(19) United States
(12) Patent Application Publication
(10) Pub. No.: US 2024/0028223 A1
(43) Pub. Date: Jan. 25, 2024

(54) MEMORY SYSTEM

(71) Applicant: Kioxia Corporation, Tokyo (JP)

(72) Inventor: Ryo WATANABE, Kawasaki Kanagawa (JP)

(21) Appl. No.: 18/080,012

(22) Filed: Dec. 13, 2022

(30) Foreign Application Priority Data
Jul. 22, 2022 (JP) 2022-117090

(51) Int. Cl. G06F 3/06

(52) U.S. Cl. CPC G06F 3/0625; G06F 3/0679; G06F 3/0634

(57) ABSTRACT

According to one embodiment, a memory system includes a controller. In accordance with a band required for data transfer via a link between a host and the memory system, the controller sets at least one zeroth lane of the link to an operating state, sets a first lane of the link to a first low power consumption state, and sets a second lane of the link to a second low power consumption state. Power consumption in each of the first and second low power consumption states is lower than power consumption in the operating state. A duration of transition from the first low power consumption state to the operating state is different from a duration of transition from the second low power consumption state to the operating state.

### CROSS-REFERENCE TO RELATED APPLICATIONS

This application is based upon and claims the benefit of priority from Japanese Patent Application No. 2022-117090, filed Jul. 22, 2022, the entire contents of which are incorporated herein by reference.

### FIELD

Embodiments described herein relate generally to a technique for controlling a nonvolatile memory.

### BACKGROUND

The PCI Express (PCIe) (registered trademark) standard is known as one of the interface standards for connecting a host and a memory system. An interface conforming to the PCIe standard connects the host and the memory system via a transmission path that is referred to as a link. Over the link, data is transferred using a packet. The data transferred using the packet includes, for example, a request from the host to the memory system, a response from the memory system to the host, or user data.

The PCIe standard defines a function capable of setting the link to a low power consumption state even when a device is in an operating state. This function is referred to as Active State Power Management (ASPM).

When there is no packet transfer over the link for a specific period of time, the device causes the link to transition from a normal operating state to the low power consumption state according to the ASPM function. In the PCIe standard, the normal operating state is defined as, for example, a link power state L0. The low power consumption state is defined as, for example, a link power state L1.

The PCIe Gen6 (PCIe 6.0 standard) newly defines, within the link power state L0, a link power state L0p in a flow control unit (FLIT) mode. The link power state L0p is a link power state in which both data transfer and reduction of power consumption are possible. In the link power state L0p, the power consumption may be reduced by dynamically controlling the link width. The link width is the number of lanes that are in the normal operating state among lanes included in the link.

### BRIEF DESCRIPTION OF THE DRAWINGS

FIG. 1 is a block diagram illustrating an example of a configuration of an information processing system that includes a memory system according to a first embodiment.

FIG. 2 is a diagram illustrating an example of states of lanes that are set in accordance with the link width, in the memory system according to the first embodiment.

FIG. 3 is a block diagram illustrating an example of a configuration of a PCIe PHY in the memory system according to the first embodiment.

FIG. 4 is a diagram illustrating a first control example of lane circuits in the memory system according to the first embodiment.

FIG. 5 is a diagram illustrating a second control example of the lane circuits in the memory system according to the first embodiment.

FIG. 6 is a diagram illustrating a third control example of the lane circuits in the memory system according to the first embodiment.

FIG. 7 is a diagram illustrating a fourth control example of the lane circuits in the memory system according to the first embodiment.

FIG. 8 is a diagram illustrating an example of power consumption of a link in the memory system according to the first embodiment and in a memory system according to a comparative example, in a case where the link width is controlled in accordance with a required band.

FIG. 9 is a diagram illustrating a first control example of lane circuits in a memory system according to a second embodiment.

FIG. 10 is a diagram illustrating a second control example of the lane circuits in the memory system according to the second embodiment.

FIG. 11 is a diagram illustrating a third control example of the lane circuits in the memory system according to the second embodiment.

FIG. 12 is a diagram illustrating a fourth control example of the lane circuits in the memory system according to the second embodiment.

FIG. 13 is a diagram illustrating an example of power consumption of a link in the memory system according to the second embodiment and in a memory system according to a comparative example, in a case where the link width is controlled in accordance with the required band.

FIG. 14 is a diagram illustrating a first control example of lane circuits in a memory system according to a third embodiment.

FIG. 15 is a diagram illustrating a second control example of the lane circuits in the memory system according to the third embodiment.

FIG. 16 is a diagram illustrating an example of power consumption of a link in the memory system according to the third embodiment and the link in the memory system according to the first embodiment, in a case where the link width is controlled in accordance with the required band.

### DETAILED DESCRIPTION

Various embodiments will be described hereinafter with reference to the accompanying drawings.

In general, according to one embodiment, a memory system is connectable to a host. The memory system includes a nonvolatile memory and a controller. The controller controls the nonvolatile memory. In accordance with a band required for data transfer via a link between the host and the memory system, the controller sets at least one zeroth lane to an operating state, sets a first lane to a first low power consumption state, and sets a second lane to a second low power consumption state. Here, the link includes a plurality of lanes. The plurality of lanes includes the at least one zeroth lane, the first lane, and the second lane. Power consumption in each of the first low power consumption state and the second low power consumption state is lower than power consumption in the operating state. A duration of transition from the first low power consumption state to the operating state is different from a duration of transition from the second low power consumption state to the operating state.

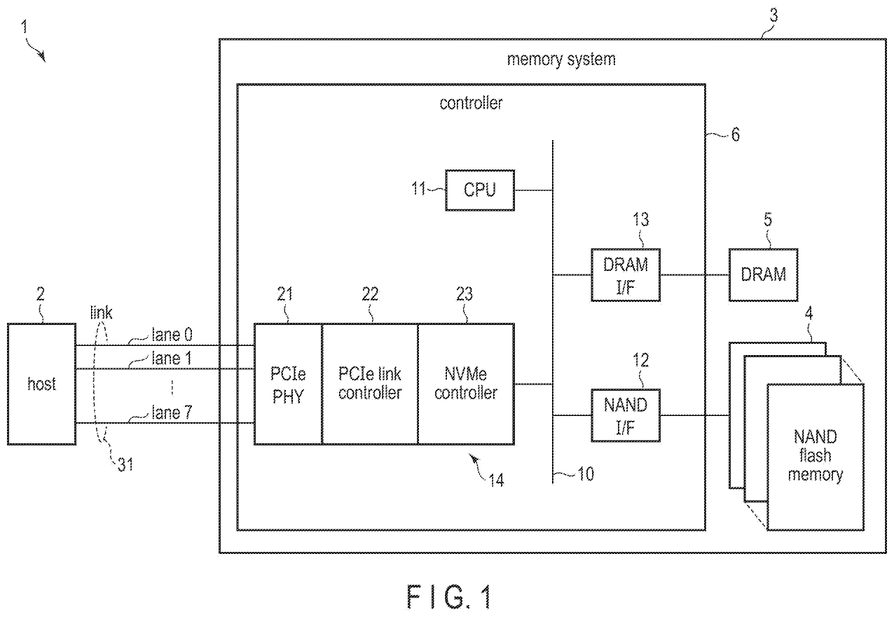

First, with reference to FIG. 1, an example of a configuration of an information processing system 1 that includes a memory system according to a first embodiment will be described. The information processing system 1 includes a host device 2 and a memory system 3.

The host device 2 is an information processing device which stores data in the memory system 3. The host device 2 is, for example, a storage server that stores a large amount of various data in the memory system 3, or a personal computer. Hereinafter, the host device 2 will be referred to as a host 2.

The memory system 3 is a semiconductor storage device configured to write data to a nonvolatile memory and read data from the nonvolatile memory. The nonvolatile memory is, for example, a NAND flash memory. The memory system 3 is also referred to as a storage device. The memory system 3 is implemented as, for example, a solid state drive (SSD).

The memory system 3 may be used as a storage for the host 2. The memory system 3 is connected to the host 2.

An interface for connecting the host 2 and the memory system 3 conforms to standards such as PCI Express (PCIe) (registered trademark) or NVM Express (NVMe) (registered trademark).

The memory system 3 includes, for example, a NAND flash memory 4, a dynamic random access memory (DRAM) 5, and a controller 6.

The NAND flash memory 4 includes one or more memory chips. Each of the memory chips includes multiple blocks. The blocks each function as a minimum unit of a data erase operation. The block may also be referred to as an erase block or a physical block. Each of the blocks includes multiple pages. Each of the pages includes memory cells connected to a single word line. The pages each function as a unit of a data write operation or a data read operation. Note that a word line may also function as a unit of a data write operation or a data read operation.

The DRAM 5 is a volatile memory. A storage area of the DRAM 5 is allocated, for example, as a storage area of firmware (FW), a cache area of a logical-to-physical address translation table, and a buffer area of user data.

The controller 6 is a memory controller that controls the NAND flash memory 4 and the DRAM 5. The controller 6 is implemented, for example, with a circuit such as a system-on-a-chip (SoC). The controller 6 may contain a static random access memory (SRAM) or a DRAM. In this case, the memory system 3 may not include the DRAM 5 on the outside of the controller 6.

The controller 6 includes, for example, a central processing unit (CPU) 11, a NAND interface (NAND I/F) 12, a DRAM interface (DRAM I/F) 13, and a host interface (host I/F) 14. These CPU 11, NAND I/F 12, DRAM I/F 13, and host I/F 14 may be connected via a bus 10.

The CPU 11 is a processor configured to control the NAND I/F 12, the DRAM I/F 13, and the host I/F 14. The CPU 11 performs various processes by executing the FW loaded from the NAND flash memory 4 onto the DRAM 5. The FW is a control program including instructions for causing the CPU 11 to execute the various processes. The CPU 11 may perform command processes to execute various commands from the host 2. The operation of the CPU 11 is controlled by the FW executed by the CPU 11.

The NAND I/F 12 electrically connects the controller 6 and the NAND flash memory 4. The NAND I/F 12 conforms to an interface standard such as a toggle double data rate (DDR) or an open NAND flash interface (ONFI).

The NAND I/F 12 functions as a NAND control circuit configured to control the NAND flash memory 4. The NAND I/F 12 may be connected to respective memory chips in the NAND flash memory 4 via multiple channels (Ch). By operating the memory chips in parallel, it is possible to broaden an access bandwidth between the controller 6 and the NAND flash memory 4.

The DRAM I/F 13 functions as a DRAM control circuit configured to control access to the DRAM 5.

The host I/F 14 is a circuit that functions as an interface that performs communication between the memory system 3 and the host 2. The host I/F 14 includes a circuit for transmitting a packet to the host 2 and a circuit for receiving a packet from the host 2. Each packet is, for example, a packet conforming to the PCIe standard. Each packet includes, for example, a command, a response, or user data. The command is, for example, an input/output (I/O) command or a various control command. The I/O command is, for example, a read command or a write command.

The host I/F 14 includes, for example, a PCIe PHY 21, a PCIe link controller 22, and an NVMe controller 23.

The PCIe PHY 21 is a circuit that connects to the host 2 via a serial interface. The serial interface includes a link 31 capable of interconnecting the host 2 and the memory system 3. The PCIe PHY 21 corresponds to the physical layer defined in the PCIe standard. The PCIe PHY 21 has, for example, a physical connection form that conforms to the PCIe standard. The PCIe PHY 21 performs an interface operation for physically transmitting and receiving data via the link 31.

The link 31 is composed of multiple lanes. Each of the lanes is a pair of a signal line for a signal transferred from the host 2 to the memory system 3, and a signal line for a signal transferred from the memory system 3 to the host 2. Each of the lanes is identified by, for example, a lane number. FIG. 1 illustrates a case where the link 31 is composed of eight lanes including a lane 0, a lane 1, . . . , and a lane 7. The lane 0, the lane 1, . . . , and the lane 7 are identified by, for example, lane numbers 0 to 7, respectively.

The PCIe link controller 22 is a circuit that manages the link 31 and performs processes for exchanging data between the PCIe PHY 21 and the NVMe controller 23. More specifically, the PCIe link controller 22 receives a packet from the host 2 via the link 31 and the PCIe PHY 21. The PCIe link controller 22 processes the packet and thereby acquiring, for example, data to be sent to the NVMe controller 23. The PCIe link controller 22 sends the acquired data to the NVMe controller 23. The data to be sent to the NVMe controller 23 is, for example, data related to access to the NAND flash memory 4. More specifically, the data to be sent to the NVMe controller 23 is, for example, a write request, a read request, and a vendor-defined message (VDM) to the NAND flash memory 4.

The NVMe controller 23 is a circuit that processes transactions such as a write request, a read request, and a VDM to the NAND flash memory 4. The NVMe controller 23 performs an operation according to a request included in data that has been received via the PCIe PHY 21 and the PCIe link controller 22, and an operation for transmitting data via the PCIe PHY 21 and the PCIe link controller 22, which includes a response to a request. The operations performed by the NVMe controller 23 conform to, for example, the NVMe standard.

In this manner, the PCIe PHY 21, the PCIe link controller 22, and the NVMe controller 23 control data transfer between the host 2 and the memory system 3.

Note that the function of each unit in the controller 6 may be realized by dedicated hardware in the controller 6 or may be realized by the CPU 11 executing the FW.

Hereinafter, a link power state set for a link will be explained. The link power state is a power state set for the link. The link power state is set according to, for example, the ASPM function defined in the PCIe standard. More specifically, the link power state is controlled by, for example, the PCIe link controller 22 that has the ASPM function. The ASPM function is a function capable of setting the link to a low power consumption state even when a device (e.g., the memory system 3) is in an operating state. The link power state includes, for example, a link power state L0 and a link power state L1. The link power state L0 is a normal operating state (active state). The link power state L1 is a low power consumption state (inactive state).

The link power state L0 may include a link power state L0p. The link power state L0p is a link power state in the FLIT mode that is newly defined in the PCIe Gen6. The FLIT mode is a mode in which retransmission of data at the physical layer is possible. In the FLIT mode, data received from an upper layer is divided into, for example, FLIT packets of 256-byte units, and retransmission control is performed in units of a FLIT packet. The link power state L0p is a link power state in which both data transfer and reduction of power consumption are possible. In the link power state L0p, at least one lane is maintained in the normal operating state (i.e., a state in which data transfer is possible). Thus, in the link power state L0p, the link keeps active with the at least one lane maintained in the normal operating state. In the link power state L0p, power consumption may be reduced by dynamically controlling the link width.

While the link is in the link power state L0p, each of the lanes included in the link is set to either the normal operating state or the low power consumption state. A lane in the normal operating state is also referred to as an active lane. A lane in the low power consumption state is also referred to as an inactive lane. An inactive lane of the link that has transitioned to the link power state L0p is expected to achieve the same degree of reduction of power consumption as a lane of the link that has transitioned to the link power state L1. The link width is represented by the number N of active lanes of the lanes included in the link. The link width is expressed as, for example, “xN”. According to the PCIe standard, for example, in a case where the link is composed of eight lanes, the link width is set to any one of x1, x2, x4, and x8. That is, while the link is in the link power state L0p, one, two, four, or eight lanes are set to the normal operating state among the eight lanes of the link. The remaining lanes are set to the low power consumption state.

The respective states set for the eight lanes when the link 31 transitions to the link power state L0p will be specifically explained. The eight lanes are a lane 0, a lane 1, . . . , and a lane 7.

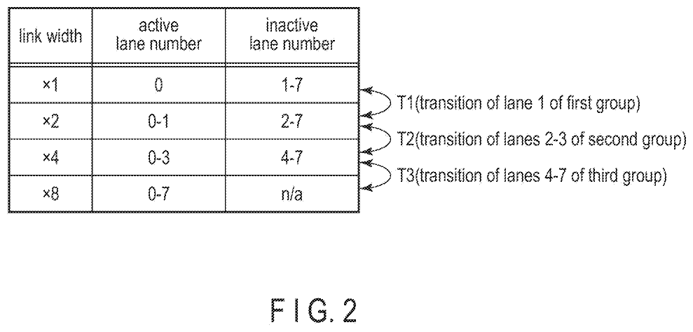

FIG. 2 illustrates an example of states of the lanes that are set in accordance with the link width. FIG. 2 illustrates the lane numbers of active lanes and the lane numbers of inactive lanes in a case where the link width is xN (N=1, 2, 4, and 8). Note that the lane 0 is a lane that is always set to the normal operating state irrespective of the link width. That is, the lane 0 is a lane that is always active irrespective of the link width.

When the link width is x1, the lane 0 is set to the normal operating state and the seven lanes 1 to 7 are set to the low power consumption state. That is, in this case, one lane corresponding to the link width x1 (i.e., the lane 0) is an active lane, and the remaining seven lanes (i.e., the lanes 1 to 7) are inactive lanes.

When the link width is x2, the two lanes 0 and 1 are set to the normal operating state and the six lanes 2 to 7 are set to the low power consumption state. That is, in this case, the two lanes corresponding to the link width x2 (i.e., the lanes 0 and 1) are active lanes, and the remaining six lanes (i.e., the lanes 2 to 7) are inactive lanes.

When the link width is x4, the four lanes 0 to 3 are set to the normal operating state and the four lanes 4 to 7 are set to the low power consumption state. That is, in this case, the four lanes corresponding to the link width x4 (i.e., the lanes 0 to 3) are active lanes, and the remaining four lanes (i.e., the lanes 4 to 7) are inactive lanes.

When the link width is x8, the eight lanes 0 to 7 are set to the normal operating state. That is, in this case, the eight lanes corresponding to the link width x8 (i.e., the lanes 0 to 7) are active lanes.

Here, the units of lanes whose states transition when the link width is expanded or narrowed will be explained.

When the link width is expanded, in the link 31, lanes transition from the low power consumption state to the normal operating state in specific units that correspond to the expanded link width. Specifically, when the link width is expanded from x1 to x2, one lane (the lane 1) transitions from the low power consumption state to the normal operating state (T1 in FIG. 2). When the link width is expanded from x2 to x4, two lanes (the lanes 2 and 3) transition from the low power consumption state to the normal operating state (T2 in FIG. 2). When the link width is expanded from x4 to x8, four lanes (the lanes 4, 5, 6, and 7) transition from the low power consumption state to the normal operating state (T3 in FIG. 2).

Similarly, also when the link width is narrowed, in the link 31, lanes transition from the normal operating state to the low power consumption state in specific units that correspond to the narrowed link width. Specifically, when the link width is narrowed from x8 to x4, four lanes (the lanes 4, 5, 6, and 7) transition from the normal operating state to the low power consumption state (T3 in FIG. 2). When the link width is narrowed from x4 to x2, two lanes (the lanes 2 and 3) transition from the normal operating state to the low power consumption state (T2 in FIG. 2). When the link width is narrowed from x2 to x1, one lane (the lane 1) transitions from the normal operating state to the low power consumption state (T1 in FIG. 2).

In this manner, in the link 31, the states of lanes of the corresponding unit transition in response to the expansion or narrowing of the link width. Hereinafter, the one lane whose state transitions when the link width varies between x1 and x2 (i.e., the lane 1) will be also referred to as a lane of a first group. The two lanes whose states transition when the link width varies between x2 and x4 (i.e., the lanes 2 and 3) will be also referred to as lanes of a second group. The four lanes whose states transition when the link width varies between x4 and x8 (i.e., the lanes 4, 5, 6, and 7) will be also referred to as lanes of a third group. The lane 0, which is set to the normal operating state irrespective of the link width, will be also referred to as a lane of a zeroth group.

In the following description, a power reduction effect and an exit latency in a case where the link 31 transitions to the link power state L0p will be explained.

When the link 31 that has transitioned to the link power state L1 returns to the link power state L0, a delay (i.e., exit latency) of several microseconds occurs, for example. Because of the delay, the performance of packet transfer via the link 31 may be degraded. The same delay may occur also when a lane returns from the low power consumption state to the normal operating state in the link 31 that has transitioned to the link power state L0p.

The PCIe Gen6 does not specifically define the degree of reduction of power consumption to be achieved in an inactive lane when the link 31 is in the link power state L0p. However, in the information processing system 1 conforming to the PCIe Gen6, it is generally assumed that all the inactive lanes in the link 31 are set to the same low power consumption state. This assumption is based on the fact that all the lanes of the link 31 which has transitioned to link power state L1 are generally set to the same low power consumption state.

When all the inactive lanes in the link 31 are set to the same low power consumption state, it is conceivable that circuits related to the inactive lanes are controlled, for example, as in the two cases (case 1 and case 2) described below in terms of the exit latency and the power reduction effect. The exit latency here is a duration required for a lane to return from the low power consumption state to the normal operating state. More specifically, the exit latency is a duration from the time when the expanding of the link width is required in response to an increase of a required band to the time when the corresponding lane transitions from the low power consumption state to the normal operating state in response to the request (i.e., the time when the link width is actually expanded). The required band is a band required for packet transfer between the host 2 and the memory system 3 via the link 31. The controller 6 may project the required band, for example, on the basis of the number of commands that have not been accepted yet by the memory system 3 after being issued by the host 2.

The issuance of a command by the host 2 means that, for example, the host 2 stores the command in a memory (e.g., a submission queue) in the host 2 and writes the value of a pointer indicative of the location where the command is stored into a register (i.e., a submission queue tail doorbell register) in the memory system 3. The acceptance of a command by the memory system 3 means that, for example, the memory system 3 (more specifically, the controller 6) fetches the command from the memory in the host 2 and starts processing according to the fetched command. The controller 6 may manage the number of commands that have not been accepted yet by the memory system 3 after being issued by the host 2, for example, on the basis of the difference between a pointer indicative of the location where a command to be fetched (i.e., a submission queue head doorbell register) and the submission queue tail doorbell register.

In addition, the time when the expanding of the link width is required in response to the increase of the required band is, for example, the time when the required band exceeds a threshold value. The power reduction effect represents the magnitude of power consumption reduced by the transition of a lane from the normal operating state to the low power consumption state. Note that circuits related to the state of each lane will be hereinafter also referred to as a lane circuit.

(Case 1) The shortening of the exit latency is prioritized, and the reduction of power consumption is restrained.

In the case 1, even when the link width is narrowed, the power reduction effect of the link 31 is small. That is, even when the number of inactive lanes increases, the power reduction effect of each inactive lane is small, and thus the power reduction effect of the link 31 is small. Accordingly, the power reduction effect of the link 31 during an active idle period is small. The active idle period is a period for which the link width is narrowed (e.g., a period for which the link width is x1).

(Case 2) The reduction of power consumption is prioritized, and the exit latency is extended.

In the case 2, since the exit latency is extended, it is hesitated to narrow the link width. Whether to narrow the link width is determined on the basis of, for example, the projected required band and the exit latency from the narrowed link width. When the exit latency is long, the link width cannot be expanded speedily in response to the increase of the required band, and it is therefore hesitated to narrow the link width. In addition, if the link width is determined not to be narrowed, the power reduction effect is small.

In the memory system 3 according to the present embodiment, when the link 31 is in the link power state L0p, inactive lanes are set to different low power consumption states per lane or per unit of lanes (i.e., group of lanes) whose states transition simultaneously. Accordingly, in the memory system 3, for example, the operation of the lane circuits when the link width is narrowed can be optimized to achieve an exit latency and a power reduction effect that are suitable for a usage situation of the link 31.

The state of each lane of the link 31 is controlled by the PCIe PHY 21.

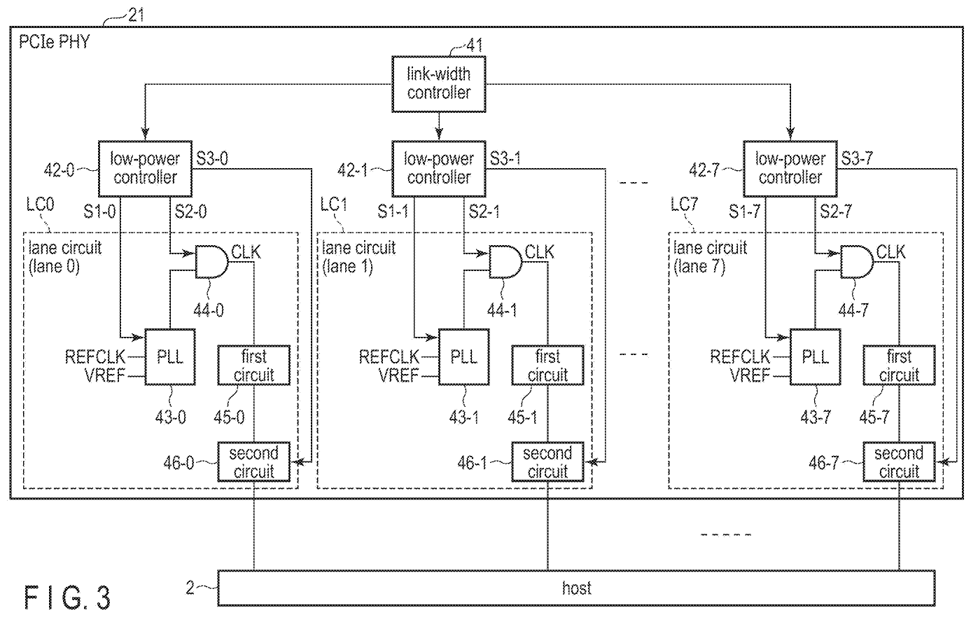

FIG. 3 illustrates an example of a configuration of the PCIe PHY 21. The description here explains a case where the link 31 is composed of eight lanes (i.e., lanes 0 to 7).

The PCIe PHY 21 includes, for example, a link-width controller 41, eight low-power controllers 42 (i.e., low-power controllers 42-0, 42-1, . . . , and 42-7), and eight lane circuits LC (i.e., lane circuits LC0, LC1, . . . , and LC7). The link-width controller 41 is connected to the low-power controllers 42-0 to 42-7. The low-power controllers 42-0 to 42-7 are connected to the lane circuits LC0 to LC7, respectively. That is, the low-power controllers 42-0 to 42-7 correspond to the lane circuits LC0 to LC7, respectively.

A set of a low-power controller 42 and its corresponding lane circuit LC corresponds to one lane. For example, the set of the low-power controller 42-0 and the lane circuit LC0 corresponds to the lane 0. The set of the low-power controller 42-1 and the lane circuit LC1 corresponds to the lane 1. The set of the low-power controller 42-7 and the lane circuit LC7 corresponds to the lane 7.

The link-width controller 41 is a circuit that controls the link width in accordance with the required band when the link 31 is in the link power state L0p. The link-width controller 41 notifies each of the low-power controllers 42-0 to 42-7 of the link width that corresponds to the required band.

More specifically, the NVMe controller 23 projects the required band, for example, on the basis of the number of commands that have not been accepted yet by the memory system 3 after being issued by the host 2. That is, the NVMe controller 23 projects the required band on the basis of the number of commands that have not been fetched from the memory in the host 2 by the memory system 3 and have not been started being processed yet, after the value of the pointer was written to the register in the memory system 3 in response to each of the commands being stored in the memory in the host 2. The NVMe controller 23 notifies the link-width controller 41 of the projected required band. Then, the link-width controller 41 determines the link width on the basis of the notified required band and threshold values.

For example, in a case where the total number of lanes included in the link 31 is eight, three threshold values for determining the link width are set on the basis of bands that correspond to link widths x1, x2, x4, and x8, respectively. The three threshold values are a first threshold value, a second threshold value, and a third threshold value. The first threshold value is a threshold value for determining which of the bands corresponding to the link widths x1 and x2 the required band is. The second threshold value is a threshold value for determining which of the bands corresponding to the link widths x2 and x4 the required band is. The third threshold value is a threshold value for determining which of the bands corresponding to the link widths x4 and x8 the required band is. The first threshold value is smaller than the second threshold value. The second threshold value is smaller than the third threshold value.

The link-width controller 41 determines that the link width is x1, when the required band is smaller than or equal to the first threshold value. The link-width controller 41 determines that the link width is x2, when the required band exceeds the first threshold value and is smaller than or equal to the second threshold value. The link-width controller 41 determines that the link width is x4, when the required band exceeds the second threshold value and is smaller than or equal to the third threshold value. The link-width controller 41 determines that the link width is x8, when the required band exceeds the third threshold value.

Then, the link-width controller 41 notifies each of the low-power controllers 42-0 to 42-7 of the determined link width.

Each of the low-power controllers 42-0 to 42-7 is a circuit that controls at least part of the corresponding one of the lane circuits LC0 to LC7 in accordance with the link width notified by the link-width controller 41. Each of the low-power controllers 42-0 to 42-7 may send a control signal to a partial circuit of the corresponding lane circuit LC. The control signal is a signal that activates or deactivates the partial circuit of the lane circuit LC or a function of the partial circuit. When the partial circuit of the lane circuit LC is activated, the control signal is asserted, for example. When the partial circuit of the lane circuit LC is deactivated (i.e., stopped), the control signal is negated, for example. Alternatively, when the function (e.g., clock gating function) of the partial circuit of the lane circuit LC is activated, the control signal is asserted, for example. In addition, when the function of the partial circuit of the lane circuit LC is deactivated, the control signal is negated, for example. The asserted control signal is a control signal in an active state. The negated control signal is a control signal in an inactive state.

More specifically, for example, the low-power controller 42-0 controls at least part of the lane circuit LC0 in accordance with the notified link width. For example, the low-power controller 42-0 sends control signals S1-0, S2-0, and S3-0 to control the lane circuit LC0.

The low-power controller 42-1 controls at least part of the lane circuit LC1 in accordance with the notified link width. The low-power controller 42-1 sends control signals S1-1, S2-1, and S3-1 to control the lane circuit LC1.

The low-power controller 42-7 controls at least part of the lane circuit LC7 in accordance with the notified link width. The low-power controller 42-7 sends control signals S1-7, S2-7, and S3-7 to control the lane circuit LC7.

Each of the lane circuits LC0 to LC7 is a circuit that controls a signal transferred between the memory system 3 and the host 2 via the corresponding lane. The lane circuits LC0 to LC7 are connected to the host 2. The operation of each of the lane circuits LC0 to LC7 is controlled in accordance with the state set for the corresponding lane. That is, each of the lane circuits LC0 to LC7 is a circuit related to the state of the corresponding lane. The state set for a lane is either the normal operating state or the low power consumption state.

The lane circuit LC0 includes, for example, a phase-locked loop (PLL) circuit 43-0, a clock gating circuit 44-0, a first circuit 45-0, and a second circuit 46-0.

The PLL circuit 43-0 is a circuit that generates a clock CLK used in the lane 0. The PLL circuit 43-0 is supplied with, for example, a reference clock REFCLK and a reference voltage VREF. The PLL circuit 43-0 generates the clock CLK from the reference clock REFCLK. The PLL circuit 43-0 supplies the generated clock CLK to the clock gating circuit 44-0.

The activation or deactivation of the PLL circuit 43-0 is controlled on the basis of the control signal S1-0 sent from the low-power controller 42-0. When the asserted control signal S1-0 is sent from the low-power controller 42-0, the PLL circuit 43-0 operates. That is, the PLL circuit 43-0 generates the clock CLK and supplies the clock CLK to the clock gating circuit 44-0. In contrast, when the negated control signal S1-0 is sent from the low-power controller 42-0, the PLL circuit 43-0 stops. That is, the PLL circuit 43-0 does not generate the clock CLK. Thus, the clock CLK is not supplied to the clock gating circuit 44-0.

The clock gating circuit 44-0 is a circuit that has a clock gating function. The clock gating circuit 44-0 is, for example, an AND circuit. The clock gating function is a function of controlling supply of the clock CLK to the first circuit 45-0 when the clock CLK is supplied from the PLL circuit 43-0. When the clock gating function is activated, the clock gating circuit 44-0 does not supply the clock CLK to the first circuit 45-0. When the clock gating function is deactivated, the clock gating circuit 44-0 supplies the clock CLK to the first circuit 45-0.

The activation or deactivation of the clock gating function of the clock gating circuit 44-0 is controlled on the basis of the control signal S2-0 sent from the low-power controller 42-0. When the asserted control signal S2-0 (i.e., low-level control signal S2-0) is sent from the low-power controller 42-0, the clock gating function is activated (i.e., enabled). That is, the clock gating circuit 44-0 does not supply the clock CLK to the first circuit 45-0. In contrast, when the negated control signal S2-0 (i.e., high-level control signal S2-0) is sent from the low-power controller 42-0, the clock gating function is deactivated (i.e., disabled). That is, the clock gating circuit 44-0 supplies the clock CLK to the first circuit 45-0.

The first circuit 45-0 and the second circuit 46-0 are circuits that control a signal transferred via the lane 0, using the clock CLK supplied from the clock gating circuit 44-0. For example, the first circuit 45-0 supplies a signal to the second circuit 46-0, using the clock CLK supplied from the clock gating circuit 44-0. For example, the second circuit 46-0 transmits, to the host 2, the signal supplied from the first circuit 45-0.

The activation or deactivation of the second circuit 46-0 is controlled on the basis of the control signal S3-0 sent from the low-power controller 42-0. When the asserted control signal S3-0 is sent from the low-power controller 42-0, the second circuit 46-0 operates. That is, the second circuit 46-0 transmits, to the host 2, the signal supplied from the first circuit 45-0. In contrast, when the negated control signal S3-0 is sent from the low-power controller 42-0, the second circuit 46-0 stops. That is, the second circuit 46-0 does not transmit, to the host 2, the signal supplied from the first circuit 45-0.

In this manner, when activating the PLL circuit 43-0, the low-power controller 42-0 asserts the control signal S1-0. When deactivating the PLL circuit 43-0, the low-power controller 42-0 negates the control signal S1-0. When activating the clock gating function of the clock gating circuit 44-0, the low-power controller 42-0 asserts the control signal S2-0. When deactivating the clock gating function of the clock gating circuit 44-0, the low-power controller 42-0 negates the control signal S2-0. When activating the second circuit 46-0, the low-power controller 42-0 asserts the control signal S3-0. When deactivating the second circuit 46-0, the low-power controller 42-0 negates the control signal S3-0.

The circuit whose activation or deactivation is controlled by the control signal S3-0 may be, not the second circuit 46-0, but any circuit in the lane circuit LC0. Note that no control signal is sent to the first circuit 45-0 from the low-power controller 42-0. That is, the first circuit 45-0 is a circuit whose operation is not directly controlled by the low-power controller 42-0.

The other circuits LC1 to LC7 also have the same circuit configuration as that of the lane circuit LC0. The circuits in the other lane circuits LC1 to LC7 operate in the same manner as the circuits in the lane circuit LC0.

Although some circuits are omitted in FIG. 3, a low-power controller corresponding to a lane i will be hereinafter expressed as a low-power controller 42-i. Control signals sent from the low-power controller 42-i will be expressed as control signals S1-i, S2-i, and S3-i. A lane circuit corresponding to the lane i will be expressed as a lane circuit LCi. Circuits in the lane circuit LCi will be expressed as a PLL circuit 43-i, a clock gating circuit 44-i, a first circuit 45-i, and a second circuit 46-i. In a case where the total number of lanes included in the link 31 is M, i is any integer of 0 to M−1.

The description here assumes that the states set for the lanes of the link 31 are optimized for a usage situation where the required band is low (e.g., the required band is lower than a threshold) for a relatively long period (e.g., such a usage situation is projected to continue longer than a threshold period). In this case, each of the low-power controllers 42-0 to 42-7 sets the low power consumption state to which the corresponding lane transitions as follows: the wider the link width at the time when the corresponding lane starts being used is, the deeper the low power consumption state is. For example, the lanes of the third group are set to a low power consumption state deeper than that of the lanes of the second group. In addition, each of the low-power controllers 42-0 to 42-7 sets the low power consumption state to which the corresponding lane transitions as follows: the narrower the link width at the time when the corresponding lane starts being used is, the shallower the low power consumption state is. For example, the lane of the first group is set to a low power consumption state shallower than that of the lanes of the second group. The start of use of a lane means that the lane transitions from a low power consumption state to the normal operating state. A deep low power consumption state is a state having a great power reduction effect and a long exit latency. A shallow low power consumption state is a state having a small power reduction effect and a short exit latency.

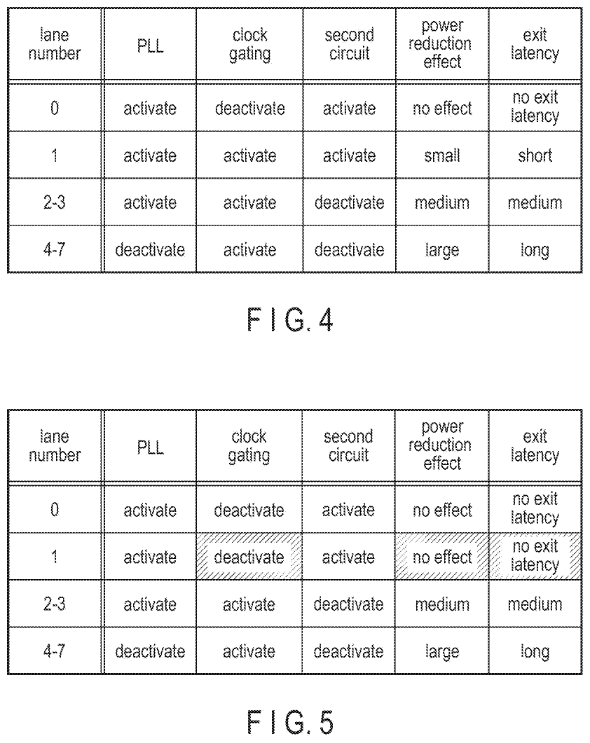

With reference to FIG. 4 to FIG. 7, an example of the control of the lane circuits LC0 to LC7 executed in accordance with the variation of the link width when the link 31 is in the link power state L0p will be explained.

<When Link Width is x1 in Link Power State L0p>

FIG. 4 illustrates a control example of the lane circuits LC0 to LC7 when the link width is x1 with the link 31 in the link power state L0p. In this case, the lane 0 (i.e., the lane of the zeroth group) is an active lane. The lanes 1 to 7 (i.e., the lanes of the first, second, and third groups) are inactive lanes. In the following description, a control example of the corresponding lane circuit LC will be explained for each group.

(Zeroth Group: Lane 0)

The low-power controller 42-0 operates the lane circuit LC0 in the normal operating state. Specifically, the low-power controller 42-0 activates the PLL circuit 43-0. The low-power controller 42-0 deactivates the clock gating function of the clock gating circuit 44-0. That is, the clock CLK is supplied to the first circuit 45-0. The low-power controller 42-0 activates the second circuit 46-0.

Thus, there is no power reduction effect in the lane circuit LC0. In addition, since the lane circuit LC0 operates in the normal operating state, there is no exit latency for returning to the normal operating state.

(First Group: Lane 1)

The low-power controller 42-1 operates the lane circuit LC1 in a low power consumption state. Specifically, the low-power controller 42-1 activates the PLL circuit 43-1. The low-power controller 42-1 activates the clock gating function of the clock gating circuit 44-1. That is, the supply of the clock CLK to the first circuit 45-1 is stopped. The low-power controller 42-1 activates the second circuit 46-1. The low power consumption state set by the above-described combination will be hereinafter also referred to as a first low power consumption state.

With the above-described control, a small power reduction effect is achieved in the lane circuit LC1. This power reduction effect is due to the activation of the clock gating function of the clock gating circuit 44-1. In addition, the exit latency for the lane circuit LC1 to return to the normal operating state is short. This is because deactivating the clock gating function of the clock gating circuit 44-1 is all that is needed to return the lane circuit LC1 to the normal operating state.

In this manner, since the link width x2 at the time when the lane 1 starts being used is narrow, the low-power controller 42-1 sets the lane 1 (more specifically, the lane circuit LC1) to the shallow first low power consumption state.

(Second Group: Lanes 2 and 3)

The low-power controller 42-2 operates the lane circuit LC2 in a low power consumption state. Specifically, the low-power controller 42-2 activates the PLL circuit 43-2. The low-power controller 42-2 activates the clock gating function of the clock gating circuit 44-2. That is, the supply of the clock CLK to the first circuit 45-2 is stopped. The low-power controller 42-2 deactivates the second circuit 46-2. The low power consumption state set by the above-described combination will be hereinafter also referred to as a second low power consumption state.

In the same manner, the low-power controller 42-3 operates the lane circuit LC3 in the second low power consumption state.

With the above-described control, a medium power reduction effect greater than that of the lane circuit LC1 is achieved in each of the lane circuits LC2 and LC3. That is, the power consumption in the second low power consumption state is smaller than that in the first low power consumption state. The power reduction effect in each of the lane circuits LC2 and LC3 is due to the activation of the clock gating function of each of the clock gating circuits 44-2 and 44-3, and the deactivation of each of the second circuits 46-2 and 46-3. In addition, the exit latency for each of the lane circuits LC2 and LC3 to return to the normal operating state is a medium exit latency longer than that of the lane circuit LC1.

In this manner, since the link width x4 at the time when the lanes 2 and 3 start being used is a medium width, the low-power controllers 42-2 and 42-3 set the lanes 2 and 3 (more specifically, the lane circuits LC2 and LC3) to the second low power consumption state that has a medium power reduction effect and a medium exit latency.

(Third Group: Lanes 4, 5, 6, and 7)

The low-power controller 42-4 operates the lane circuit LC4 in a low power consumption state. Specifically, the low-power controller 42-4 deactivates the PLL circuit 43-4. The low-power controller 42-4 activates the clock gating function of the clock gating circuit 44-4. That is, the supply of the clock CLK to the first circuit 45-4 is stopped. The low-power controller 42-4 deactivates the second circuit 46-4. The low power consumption state set by the above-described combination will be hereinafter also referred to as a third low power consumption state.

In the same manner, the low-power controller 42-5 operates the lane circuit LC5 in the third low power consumption state. The low-power controller 42-6 operates the lane circuit LC6 in the third low power consumption state. The low-power controller 42-7 operates the lane circuit LC7 in the third low power consumption state.

With the above-described control, a power reduction effect greater than that of each of the lane circuits LC2 and LC3 is achieved in each of the lane circuits LC4, LC5, LC6, and LC7. In other words, the power consumption in the third low power consumption state is smaller than that in the second low power consumption state. The power reduction effect in each of the lane circuits LC4, LC5, LC6, and LC7 is due to the deactivation of each of the PLL circuits 43-4 to 43-7, the activation of the clock gating function of each of the clock gating circuits 44-4 to 44-7, and the deactivation of each of the second circuits 46-4 to 46-7. In addition, the exit latency for each of the lane circuits LC4, LC5, LC6, and LC7 to return to the normal operating state is longer than that of each of the lane circuits LC2 and LC3. This is because, for example, in order for the lane circuit LC4 to return to the normal operating state, it is necessary to activate the PLL circuit 43-4, deactivate the clock gating function of the clock gating circuit 44-4 (i.e., supply the clock CLK to the first circuit 45-4), and activate the second circuit 46-4.

In this manner, since the link width x8 at the time when the lanes 4 to 7 start being used is wide, the low-power controllers 42-4 to 42-7 set the lanes 4 to 7 (more specifically, the lane circuits LC4, LC5, LC6, and LC7) to the deep third low power consumption state.

<When Link Width is x2 in Link Power State L0p>

FIG. 5 illustrates a control example of the lane circuits LC0 to LC7 when the link width is x2 with the link 31 in the link power state L0p. In this case, the lanes 0 and 1 (i.e., the lanes of the zeroth and first groups) are active lanes. The lanes 2 to 7 (i.e., the lanes of the second and third groups) are inactive lanes. In the following description, a control example of the corresponding lane circuit LC will be explained for each group. The hatched parts in FIG. 5 indicate the controls changed in response to the expansion of the link width from x1 to x2.

(Zeroth Group: Lane 0)

The low-power controller 42-0 operates the lane circuit LC0 in the normal operating state. The specific control executed by the low-power controller 42-0, the power reduction effect, and the exit latency are the same as when the link width is x1 in the link power state L0p.

(First Group: Lane 1)

The low-power controller 42-1 operates the lane circuit LC1 in the normal operating state. Specifically, the low-power controller 42-1 activates the PLL circuit 43-1. The low-power controller 42-1 deactivates the clock gating function of the clock gating circuit 44-1. That is, the clock CLK is supplied to the first circuit 45-1. The low-power controller 42-1 activates the second circuit 46-1.

Thus, there is no power reduction effect in the lane circuit LC1. In addition, since the lane circuit LC1 operates in the normal operating state, there is no exit latency for returning to the normal operating state.

(Second Group: Lanes 2 and 3)

The low-power controller 42-2 operates the lane circuit LC2 in the second low power consumption state. The low-power controller 42-3 operates the lane circuit LC3 in the second low power consumption state. The specific control executed by the low-power controllers 42-2 and 42-3, the power reduction effect, and the exit latency are the same as when the link width is x1 in the link power state L0p.

(Third Group: Lanes 4, 5, 6, and 7)

The low-power controller 42-4 operates the lane circuit LC4 in the third low power consumption state. The low-power controller 42-5 operates the lane circuit LC5 in the third low power consumption state. The low-power controller 42-6 operates the lane circuit LC6 in the third low power consumption state. The low-power controller 42-7 operates the lane circuit LC7 in the third low power consumption state. The specific control executed by the low-power controllers 42-4 to 42-7, the power reduction effect, and the exit latency are the same as when the link width is x1 in the link power state L0p.

<When Link Width is x4 in Link Power State L0p>

FIG. 6 illustrates a control example of the lane circuits LC0 to LC7 when the link width is x4 with the link 31 in the link power state L0p. In this case, the lanes 0 to 3 (i.e., the lanes of the zeroth, first, and second groups) are active lanes. The lanes 4 to 7 (i.e., the lanes of the third group) are inactive lanes. In the following description, a control example of the corresponding lane circuit LC will be explained for each group. The hatched parts in FIG. 6 indicate the controls changed in response to the expansion of the link width from x2 to x4.

(Zeroth Group: Lane 0)

The low-power controller 42-0 operates the lane circuit LC0 in the normal operating state. The specific control executed by the low-power controller 42-0, the power reduction effect, and the exit latency are the same as when the link width is x1 in the link power state L0p.

(First Group: Lane 1)

The low-power controller 42-1 operates the lane circuit LC1 in the normal operating state. The specific control executed by the low-power controller 42-1, the power reduction effect, and the exit latency are the same as when the link width is x2 in the link power state L0p.

(Second Group: Lanes 2 and 3)

The low-power controller 42-2 operates the lane circuit LC2 in the normal operating state. Specifically, the low-power controller 42-2 activates the PLL circuit 43-2. The low-power controller 42-2 deactivates the clock gating function of the clock gating circuit 44-2. That is, the clock CLK is supplied to the first circuit 45-2. The low-power controller 42-2 activates the second circuit 46-2.

In the same manner, the low-power controller 42-3 operates the lane circuit LC3 in the normal operating state.

Thus, there is no power reduction effect in each of the lane circuits LC2 and LC3. In addition, since each of the lane circuits LC2 and LC3 operates in the normal operating state, there is no exit latency for returning to the normal operating state.

(Third Group: Lanes 4, 5, 6, and 7)

The low-power controller 42-4 operates the lane circuit LC4 in the third low power consumption state. The low-power controller 42-5 operates the lane circuit LC5 in the third low power consumption state. The low-power controller 42-6 operates the lane circuit LC6 in the third low power consumption state. The low-power controller 42-7 operates the lane circuit LC7 in the third low power consumption state. The specific control executed by the low-power controllers 42-4 to 42-7, the power reduction effect, and the exit latency are the same as when the link width is x1 in the link power state L0p.

<When Link Width is x8 in Link Power State L0p>

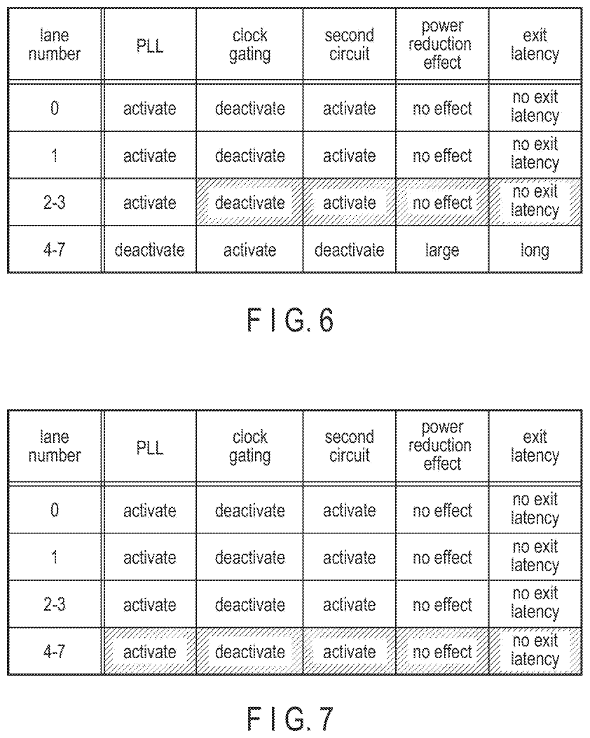

FIG. 7 illustrates a control example of the lane circuits LC0 to LC7 when the link width is x8 with the link 31 in the link power state L0p. In this case, the lanes 0 to 7 (i.e., the lanes of the zeroth, first, second, and third groups) are active lanes. In the following description, a control example of the corresponding lane circuit LC will be explained for each group. The hatched parts in FIG. 7 illustrate the controls changed in response to the expansion of the link width from x4 to x8.

(Zeroth Group: Lane 0)

The low-power controller 42-0 operates the lane circuit LC0 in the normal operating state. The specific control executed by the low-power controller 42-0, the power reduction effect, and the exit latency are the same as when the link width is x1 in the link power state L0p.

(First Group: Lane 1)

The low-power controller 42-1 operates the lane circuit LC1 in the normal operating state. The specific control executed by the low-power controller 42-1, the power reduction effect, and the exit latency are the same as when the link width is x2 in the link power state L0p.

(Second Group: Lanes 2 and 3)

The low-power controller 42-2 operates the lane circuit LC2 in the normal operating state. The low-power controller 42-3 operates the lane circuit LC3 in the normal operating state. The specific control executed by the low-power controllers 42-2 and 42-3, the power reduction effect, and the exit latency are the same as when the link width is x4 in the link power state L0p.

(Third Group: Lanes 4, 5, 6, and 7)

The low-power controller 42-4 operates the lane circuit LC4 in the normal operating state. Specifically, the low-power controller 42-4 activates the PLL circuit 43-4. The low-power controller 42-4 deactivates the clock gating function of the clock gating circuit 44-4. That is, the clock CLK is supplied to the first circuit 45-4. The low-power controller 42-4 activates the second circuit 46-4.

In the same manner, the low-power controller 42-5 operates the lane circuit LC5 in the normal operating state. The low-power controller 42-6 operates the lane circuit LC6 in the normal operating state. The low-power controller 42-7 operates the lane circuit LC7 in the normal operating state.

Thus, there is no power reduction effect in each of the lane circuits LC4, LC5, LC6, and LC7. In addition, since each of the lane circuits LC4, LC5, LC6, and LC7 operates in the normal operating state, there is no exit latency for returning to the normal operating state.

Note that each of the low-power controllers 42-0 to 42-7 stores, for example, a table that indicates the contents of the control of the corresponding lane circuit LC, among the contents of the control of the lane circuits LC0 to LC7 that are performed in accordance with the link width in the link power state L0p as illustrated in FIG. 4 to FIG. 7. Each of the low-power controllers 42-0 to 42-7 uses the table to control at least part of the corresponding lane circuit LC in accordance with the link width notified by the link-width controller 41.

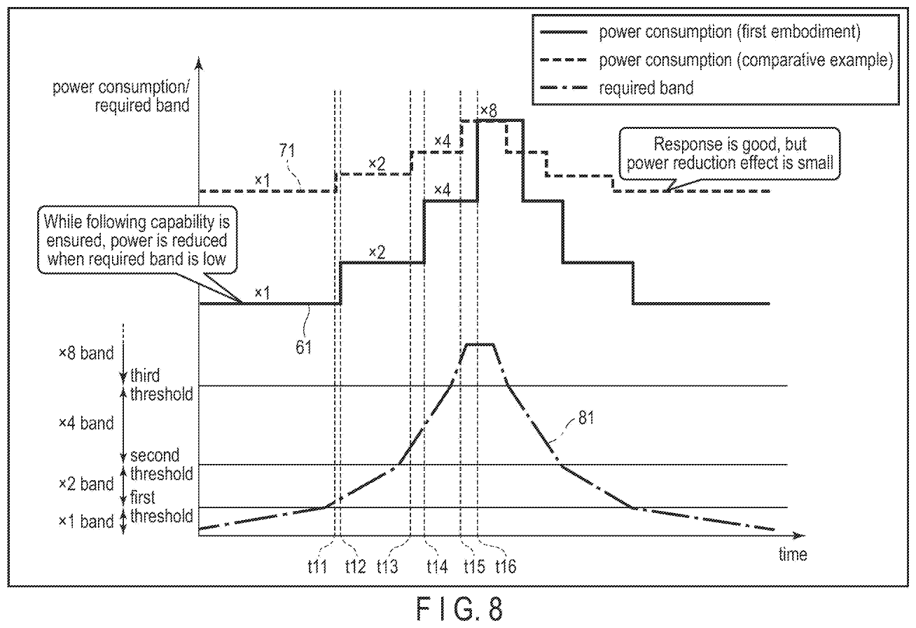

FIG. 8 is a graph indicating: an example of the power consumption of the link 31 in the memory system 3 of the first embodiment; and an example of the power consumption of a link in a memory system according to a comparative example, in a case where the link width is controlled in accordance with the required band in the usage situation where the required band is low for a relatively long period. The horizontal axis represents time. The vertical axis represents the power consumption and the required band. The description here assumes that in the memory system of the comparative example, all the inactive lanes are set to a low power consumption state in which the shortening of the exit latency is prioritized and the reduction amount of power consumption is restrained (i.e., a shallow low power consumption state). It is also assumed that with the passage of time, the required band 81 gradually increases from a band corresponding to the link width x1 to a band corresponding to the link width x8 and then gradually decreases to the band corresponding to the link width x1 again. The required band 81 represents the usage situation where h the required band is low for a relatively long period.

The power consumption 61 of the link 31 in the memory system 3 of the first embodiment and the power consumption 71 of the link in the memory system of the comparative example increase because of the expansion of the link width in response to the increase of the required band 81. In addition, the power consumption 61 and the power consumption 71 decrease because of the narrowing of the link width in response to the decrease of the required band 81.

In the memory system of the comparative example, all the inactive lanes are set to a shallow low power consumption state. In contrast, in the memory system 3 of the first embodiment, an inactive lane which starts being used when the link width is narrower is set to a shallower low power consumption state, and an inactive lane which starts being used when the link width is wider is set to a low power consumption state that has a greater power reduction effect and a longer exit latency (i.e., a deeper low power consumption state).

The exit latency of the memory system 3 of the first embodiment and the exit latency of the memory system of the comparative example will be specifically explained.

The time (i.e., return time) when the link width has been expanded from x1 to x2 in response to the required band 81 exceeding the first threshold value is time t11 in the memory system of the comparative example and is time t12 in the memory system 3 of the first embodiment. The time t11 is earlier than the time t12. The time t11 corresponds to the time when one lane (e.g., a lane 1) returns from the shallow low power consumption state to the normal operating state in the memory system of the comparative example. The time t12 corresponds to the time when one lane (e.g., the lane 1) returns from a shallow low power consumption state (e.g., the first low power consumption state) to the normal operating state in the memory system 3 of the first embodiment. The difference between the time t11 and the time t12 is relatively small.

The time when the link width has been expanded from x2 to x4 in response to the required band 81 exceeding the second threshold value is time t13 in the memory system of the comparative example and is time t14 in the memory system 3 of the first embodiment. The time t13 is earlier than the time t14. The time t13 corresponds to the time when two lanes (e.g., lanes 2 and 3) return from the shallow low power consumption state to the normal operating state in the memory system of the comparative example. The time t14 corresponds to the time when two lanes (e.g., the lanes 2 and 3) return from a relatively deep low power consumption state (e.g., the second low power consumption state) to the normal operating state in the memory system 3 of the first embodiment. Accordingly, the difference between the time t13 and the time t14 is greater than the difference between the time t11 and the time t12.

The time when the link width has been expanded from x4 to x8 in response to the required band 81 exceeding the third threshold value is time t15 in the memory system of the comparative example and is time t16 in the memory system 3 of the first embodiment. The time t15 is earlier than the time t16. The time t15 corresponds to the time when four lanes (e.g., lanes 4 to 7) return from the shallow low power consumption state to the normal operating state in the memory system of the comparative example. The time t16 corresponds to the time when four lanes (e.g., the lanes 4 to 7) return from a deep low power consumption state (e.g., the third low power consumption state) to the normal operating state in the memory system 3 of the first embodiment. Accordingly, the difference between the time t15 and the time t16 is greater than the difference between the time t13 and the time t14.

In this manner, when the link width is expanded in response to the increase of the required band 81, the return time in the memory system of the comparative example is earlier than the return time in the memory system 3 of the first embodiment. Accordingly, the exit latency in the memory system of the comparative example is shorter than the exit latency in the memory system 3 of the first embodiment. In addition, the wider the link width is, the greater the difference between the exit latencies of the memory system of the comparative example and the memory system 3 of the first embodiment is.

Next, the power consumption of the memory system 3 of the first embodiment and the power consumption of the memory system of the comparative example will be described specifically.

When the link width is x1, seven lanes (e.g., the lanes 1 to 7) are set to the shallow low power consumption state in the memory system of the comparative example. In contrast, in the memory system 3 of the first embodiment, one lane (e.g., the lane 1) is set to a shallow low power consumption state (e.g., the first low power consumption state), two lanes (e.g., the lanes 2 and 3) are set to a relatively deep low power consumption state (e.g., the second low power consumption state), and four lanes (e.g., the lanes 4 to 7) are set to a deep low power consumption state (e.g., the third low power consumption state). Accordingly, the power consumption 61 of the link 31 in the memory system 3 of the first embodiment is much lower than the power consumption 71 of the link in the memory system of the comparative example.

When the link width is x2, six lanes (e.g., the lanes 2 to 7) are set to the shallow low power consumption state in the memory system of the comparative example. In contrast, in the memory system 3 of the first embodiment, two lanes (e.g., the lanes 2 and 3) are set to the relatively deep low power consumption state (e.g., the second low power consumption state) and four lanes (e.g., the lanes 4 to 7) are set to the deep low power consumption state (e.g., the third low power consumption state). Accordingly, the power consumption 61 of the link 31 in the memory system 3 of the first embodiment is lower than the power consumption 71 of the link in the memory system of the comparative example. The difference between the power consumption 61 and the power consumption 71 when the link width is x2 is smaller than the difference between the power consumption 61 and the power consumption 71 when the link width is x1.

When the link width is x4, four lanes (e.g., lanes 4 to 7) are set to the shallow low power consumption state in the memory system of the comparative example. In contrast, in the memory system 3 of the first embodiment, four lanes (e.g., the lanes 4 to 7) are set to the deep low power consumption state (e.g., the third low power consumption state). Accordingly, the power consumption 61 of the link 31 in the memory system 3 of the first embodiment is lower than the power consumption 71 of the link in the memory system of the comparative example. The difference between the power consumption 61 and the power consumption 71 when the link width is x4 is smaller than the difference between the power consumption 61 and the power consumption 71 when the link width is x2.

Note that when the link width is x8, the power consumption 61 of the link 31 in the memory system 3 of the first embodiment is equal to the power consumption 71 of the link in the memory system of the comparative example.

In this manner, in the memory system of the comparative example, the link width is expanded in a short exit latency in response to the increase of the required band 81, but the power reduction effect is small.

In contrast, in the memory system 3 of the first embodiment, a great power reduction effect is achieved while the link width is narrow. In addition, in the memory system 3, while the required band is low, the link width can be expanded following the increased required band 81. Thus, in the memory system 3, in the usage situation where the required band is low for a relatively long period, the following capability of the link width to the required band 81 can be ensured. The following capability of the link width in the memory system 3 is inferior to the following capability of the link width in the comparative example; however, in the usage situation where the required band is low for a relatively long period, the possibility that it becomes necessary to expand the link width is low in the first place. Thus, the degradation of the performance of packet transfer is not considered a problem.

Accordingly, in the memory system 3, the operation of the lane circuits LC when the link width is narrowed can be optimized to achieve an exit latency and a power reduction effect that are suitable for the usage situation of the link 31 where the required band is low for a relatively long period.

### Second Embodiment

In the first embodiment, each lane of the link 31 is controlled in the usage situation of the link 31 where the required band is low for a relatively long period. In contrast, in a second embodiment, each lane of the link 31 is controlled in a usage situation of the link 31 where the required band is high for a relatively long period.

The configuration of the memory system 3 according to the second embodiment is the same as that of the memory system 3 of the first embodiment. The second embodiment and the first embodiment are different in the control operation of the lanes performed by the low-power controllers 42-0 to 42-7. In the following description, points different from those of the first embodiment will be mainly explained.

The description here assumes that states set for the lanes of the link 31 are optimized for the usage situation where the required band is high (e.g., the required band is higher than a threshold, for example) for a relatively long period (e.g., such a usage situation is projected to continue longer than a threshold period). In this case, each of the low-power controllers 42-0 to 42-7 sets, for example, a low power consumption state to which a lane that starts being used only when the link width is the maximum link width (e.g., x8) transitions, to a shallow low power consumption state. For example, the lanes of the third group are set to the shallow low power consumption state (e.g., the first low power consumption state). In addition, each of the low-power controllers 42-0 to 42-7 sets, for example, a low power consumption state to which a lane that starts being used even when the link width is not the maximum link width transitions, to a deep low power consumption state. For example, the lanes of the first and second groups are set to the deep low power consumption state (e.g., the third low power consumption state).

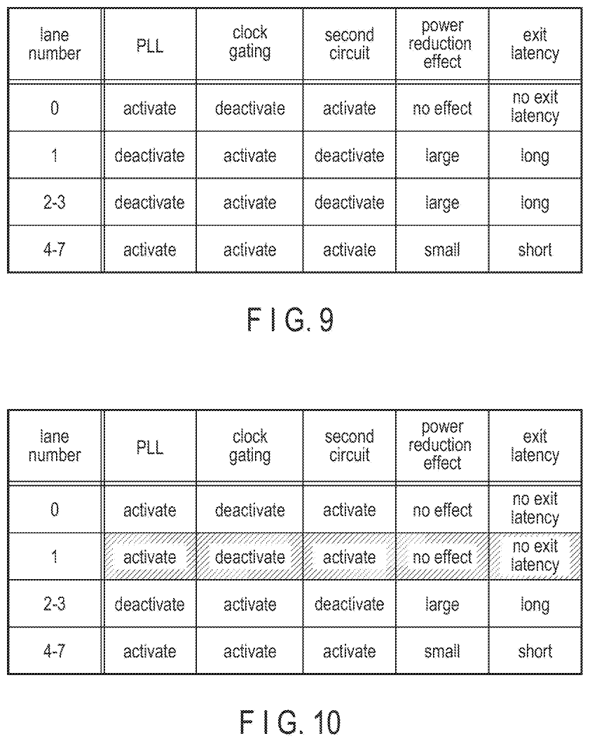

With reference to FIG. 9 to FIG. 12, an example of the control of the lane circuits LC0 to LC7 performed in accordance with the variation of the link width when the link 31 is in the link power state L0p will be explained.

<When Link Width is x1 in Link Power State L0p>

FIG. 9 illustrates a control example of the lane circuits LC0 to LC7 when the link width is x1 with the link 31 in the link power state L0p. In this case, the lane 0 (i.e., the lane of the zeroth group) is an active lane. The lanes 1 to 7 (i.e., the lanes of the first, second, and third groups) are inactive lanes. In the following description, a control example of the corresponding lane circuit LC will be explained for each group.

(Zeroth Group: Lane 0)

The low-power controller 42-0 operates the lane circuit LC0 in the normal operating state. Specifically, the low-power controller 42-0 activates the PLL circuit 43-0. The low-power controller 42-0 deactivates the clock gating function of the clock gating circuit 44-0. That is, the clock CLK is supplied to the first circuit 45-0. The low-power controller 42-0 activates the second circuit 46-0.

Thus, there is no power reduction effect in the lane circuit LC0. In addition, since the lane circuit LC0 operates in the normal operating state, there is no exit latency for returning to the normal operating state.

(First Group: Lane 1)

The low-power controller 42-1 operates the lane circuit LC1 in the third low power consumption state. Specifically, the low-power controller 42-1 deactivates the PLL circuit 43-1. The low-power controller 42-1 activates the clock gating function of the clock gating circuit 44-1. That is, the supply of the clock CLK to the first circuit 45-1 is stopped. The low-power controller 42-1 deactivates the second circuit 46-1.

With the above-described control, a great power reduction effect is achieved in the lane circuit LC1. This power reduction effect is due to the deactivation of the PLL circuit 43-1, the activation of the clock gating function of the clock gating circuit 44-1, and the deactivation of the second circuit 46-1. In addition, the exit latency for the lane circuit LC1 to return to the normal operating state is long. This is because, in order for the lane circuit LC1 to return to the normal operating state, it is necessary to activate the PLL circuit 43-1, deactivate the clock gating function of the clock gating circuit 44-1 (i.e., supply the clock CLK to the first circuit 45-1), and activate the second circuit 46-1.

In this manner, the low-power controller 42-1 sets the lane 1 (more specifically, the lane circuit LC1) which starts being used even when the link width is x2 (i.e., not the maximum link width), to the deep third low power consumption state.

(Second Group: Lanes 2 and 3)

The low-power controller 42-2 operates the lane circuit LC2 in the third low power consumption state. Specifically, the low-power controller 42-2 deactivates the PLL circuit 43-2. The low-power controller 42-2 activates the clock gating function of the clock gating circuit 44-2. That is, the supply of the clock CLK to the first circuit 45-2 is stopped. The low-power controller 42-2 deactivates the second circuit 46-2.

In the same manner, the low-power controller 42-3 operates the lane circuit LC3 in the third low power consumption state.

With the above-described control, a great power reduction effect is achieved in each of the lane circuits LC2 and LC3. In addition, the exit latencies for the lane circuits LC2 and LC3 to return to the normal operating state are long.

In this manner, the low-power controllers 42-2 and 42-3 set the lanes 2 and 3 (more specifically, the lane circuits LC2 and LC3) which start being used even when the link width is x4 (i.e., not the maximum link width), to the deep third low power consumption state.

(Third Group: Lanes 4, 5, 6, and 7)

The low-power controller 42-4 operates the lane circuit LC4 in the first low power consumption state. Specifically, the low-power controller 42-4 activates the PLL circuit 43-4. The low-power controller 42-4 activates the clock gating function of the clock gating circuit 44-4. That is, the supply of the clock CLK to the first circuit 45-4 is stopped. The low-power controller 42-4 activates the second circuit 46-4.

In the same manner, the low-power controller 42-5 operates the lane circuit LC5 in the first low power consumption state. The low-power controller 42-6 operates the lane circuit LC6 in the first low power consumption state. The low-power controller 42-7 operates the lane circuit LC7 in the first low power consumption state.

With the above-described control, a power reduction effect smaller than that of each of the lane circuits LC1, LC2, and LC3 is achieved in each of the lane circuits LC4 to LC7. In other words, the power consumption in the first low power consumption state is greater than the power consumption in the third low power consumption state. The power reduction effect in each of the lane circuits LC4 to LC7 is due to the activation of the clock gating function of each of the clock gating circuits 44-4 to 44-7. In addition, the exit latency for each of the lane circuits LC4 to LC7 to return to the normal operating state is shorter than the exit latency of each of the lane circuits LC1, LC2, and LC3. This is because deactivating the clock gating function of each of the clock gating circuits 44-4 to 44-7 is all that is needed to return the corresponding one of the lane circuits LC4 to LC7 to the normal operating state.

In this manner, the low-power controllers 42-4 to 42-7 set the lanes 4 to 7 (more specifically, the lane circuits LC4 to LC7) which start being used only when the link width is x8 (i.e., the maximum link width), to the shallow first low power consumption state.

<When Link Width is x2 in Link Power State L0p>

FIG. 10 illustrates a control example of the lane circuits LC0 to LC7 when the link width is x2 with the link 31 in the link power state L0p. In this case, the lanes 0 and 1 (i.e., the lanes of the zeroth and first groups) are active lanes. The lanes 2 to 7 (i.e., the lanes of the second and third groups) are inactive lanes. In the following description, a control example of the corresponding lane circuit LC will be explained for each group. The hatched parts in FIG. 10 indicate the controls changed in response to the expansion of the link width from x1 to x2.

(Zeroth Group: Lane 0)

The low-power controller 42-0 operates the lane circuit LC0 in the normal operating state. The specific control performed by the low-power controller 42-0, the power reduction effect, and the exit latency are the same as when the link width is x1 in the link power state L0p.

(First Group: Lane 1)

The low-power controller 42-1 operates the lane circuit LC1 in the normal operating state. Specifically, the low-power controller 42-1 activates the PLL circuit 43-1. The low-power controller 42-1 deactivates the clock gating function of the clock gating circuit 44-1. That is, the clock CLK is supplied to the first circuit 45-1. The low-power controller 42-1 activates the second circuit 46-1.

Thus, there is no power reduction effect in the lane circuit LC1. In addition, since the lane circuit LC1 operates in the normal operating state, there is no exit latency for returning to the normal operating state.

(Second Group: Lanes 2 and 3)

The low-power controller 42-2 operates the lane circuit LC2 in the third low power consumption state. The low-power controller 42-3 operates the lane circuit LC3 in the third low power consumption state. The specific control performed by the low-power controllers 42-2 and 42-3, the power reduction effect, and the exit latency are the same as when the link width is x1 in the link power state L0p.

(Third Group: Lanes 4, 5, 6, and 7)

The low-power controller 42-4 operates the lane circuit LC4 in the first low power consumption state. The low-power controller 42-5 operates the lane circuit LC5 in the first low power consumption state. The low-power controller 42-6 operates the lane circuit LC6 in the first low power consumption state. The low-power controller 42-7 operates the lane circuit LC7 in the first low power consumption state. The specific control performed by the low-power controllers 42-4 to 42-7, the power reduction effect, and the exit latency are the same as when the link width is x1 in the link power state L0p.

<When Link Width is x4 in Link Power State L0p>

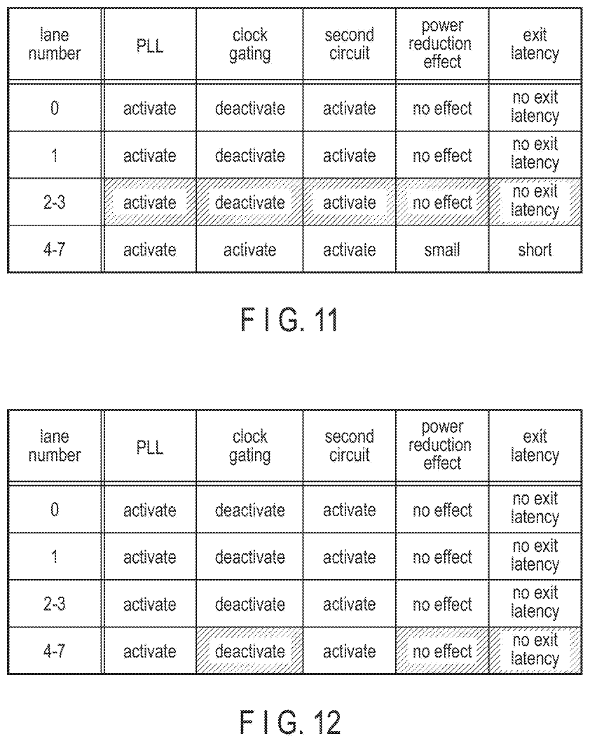

FIG. 11 illustrates a control example of the lane circuits LC0 to LC7 when the link width is x4 with the link 31 in the link power state L0p. In this case, the lanes 0 to 3 (i.e., the lanes of the zeroth, first, and second groups) are active lanes. The lanes 4 to 7 (i.e., the lanes of the third group) are inactive lanes. In the following description, a control example of the corresponding lane circuit LC will be explained for each group. The hatched parts in FIG. 11 indicate the controls changed in response to the expansion of the link width from x2 to x4.

(Zeroth Group: Lane 0)

The low-power controller 42-0 operates the lane circuit LC0 in the normal operating state. The specific control performed by the low-power controller 42-0, the power reduction effect, and the exit latency are the same as when the link width is x1 in the link power state L0p.

(First Group: Lane 1)

The low-power controller 42-1 operates the lane circuit LC1 in the normal operating state. The specific control performed by the low-power controller 42-1, the power reduction effect, and the exit latency are the same as when the link width is x2 in the link power state L0p.

(Second Group: Lanes 2 and 3)

The low-power controller 42-2 operates the lane circuit LC2 in the normal operating state. Specifically, the low-power controller 42-2 activates the PLL circuit 43-2. The low-power controller 42-2 deactivates the clock gating function of the clock gating circuit 44-2. That is, the clock CLK is supplied to the first circuit 45-2. The low-power controller 42-2 activates the second circuit 46-2.

In the same manner, the low-power controller 42-3 operates the lane circuit LC3 in the normal operating state.

Thus, there is no power reduction effect in each of the lane circuits LC2 and LC3. In addition, since each of the lane circuits LC2 and LC3 operates in the normal operating state, there is no exit latency for returning to the normal operating state.

(Third Group: Lanes 4, 5, 6, and 7)

The low-power controller 42-4 operates the lane circuit LC4 in the first low power consumption state. The low-power controller 42-5 operates the lane circuit LC5 in the first low power consumption state. The low-power controller 42-6 operates the lane circuit LC6 in the first low power consumption state. The low-power controller 42-7 operates the lane circuit LC7 in the first low power consumption state. The specific control performed by the low-power controllers 42-4 to 42-7, the power reduction effect, and the exit latency are the same as when the link width is x1 in the link power state L0p.

<When Link Width is x8 in Link Power State L0p>

FIG. 12 illustrates a control example of the lane circuits LC0 to LC7 when the link width is x8 with the link 31 in the link power state L0p. In this case, the lanes 0 to 7 (i.e., the lanes of the zeroth, first, second, and third groups) are active lanes. In the following description, a control example of the corresponding lane circuit LC will be explained for each group. The hatched parts in FIG. 12 illustrate the controls changed in response to the expansion of the link width from x4 to x8.

(Zeroth Group: Lane 0)

The low-power controller 42-0 operates the lane circuit LC0 in the normal operating state. The specific control performed by the low-power controller 42-0, the power reduction effect, and the exit latency are the same as when the link width is x1 in the link power state L0p.

(First Group: Lane 1)

The low-power controller 42-1 operates the lane circuit LC1 in the normal operating state. The specific control performed by the low-power controller 42-1, the power reduction effect, and the exit latency are the same as when the link width is x2 in the link power state L0p.

(Second Group: Lanes 2 and 3)

The low-power controller 42-2 operates the lane circuit LC2 in the normal operating state. The low-power controller 42-3 operates the lane circuit LC3 in the normal operating state. The specific control performed by the low-power controllers 42-2 and 42-3, the power reduction effect, and the exit latency are the same as when the link width is x4 in the link power state L0p.

(Third Group: Lanes 4, 5, 6, and 7)

The low-power controller 42-4 operates the lane circuit LC4 in the normal operating state. Specifically, the low-power controller 42-4 activates the PLL circuit 43-4. The low-power controller 42-4 deactivates the clock gating function of the clock gating circuit 44-4. That is, the clock CLK is supplied to the first circuit 45-4. The low-power controller 42-4 activates the second circuit 46-4.

In the same manner, the low-power controller 42-5 operates the lane circuit LC5 in the normal operating state. The low-power controller 42-6 operates the lane circuit LC6 in the normal operating state. The low-power controller 42-7 operates the lane circuit LC7 in the normal operating state.

Thus, there is no power reduction effect in each of the lane circuits LC4, LC5, LC6, and LC7. In addition, since each of the lane circuits LC4, LC5, LC6, and LC7 operates in the normal operating state, there is no exit latency for returning to the normal operating state.

Note that each of the low-power controllers 42-0 to 42-7 stores, for example, a table that indicates the contents of the control of the corresponding lane circuit LC, among the contents of the control of the lane circuits LC0 to LC7 that are performed in accordance with the link width in the link power state L0p as illustrated in FIG. 9 to FIG. 12. Each of the low-power controllers 42-0 to 42-7 uses the table to control at least part of the corresponding lane circuit LC in accordance with the link width notified by the link-width controller 41.

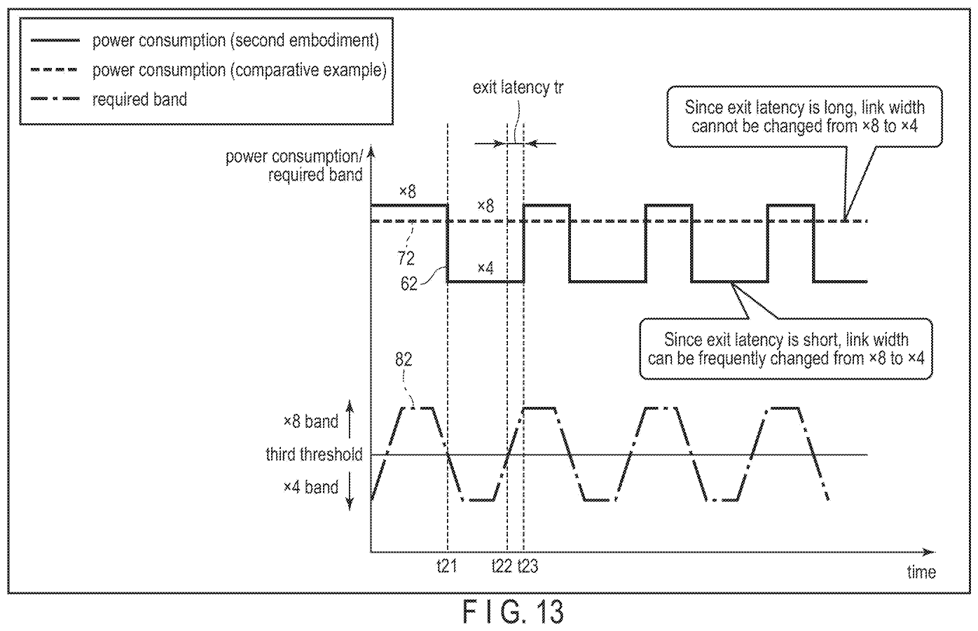

FIG. 13 is a graph indicating: an example of the power consumption of the link 31 in the memory system 3 of the second embodiment; and an example of the power consumption of a link in a memory system according to a comparative example, in a case where the link width is controlled in accordance with the required band in the usage situation where the required band is high for a relatively long period. The horizontal axis represents time. The vertical axis represents the power consumption and the required band. The description here assumes that in the memory system of the comparative example, all the inactive lanes are set to a low power consumption state in which the reduction of power consumption is prioritized and the exit latency is extended (i.e., a deep low power consumption state). It is also assumed that with the passage of time, the required band 82 repeatedly increases above and decreases below a threshold value between the bands corresponding to link widths x4 and x8 (i.e., the third threshold value). That is, the required band 82 represents the usage situation where the required band is high for a relatively long period.

The power consumption 62 of the link 31 in the memory system 3 of the second embodiment and the power consumption 72 of the link in the memory system of the comparative example increase because of the expansion of the link width in response to the increase of the required band 82. In addition, the power consumption 62 and the power consumption 72 decrease because of the narrowing of the link width in response to the decrease of the required band 82.

In the memory system of the comparative example, all the inactive lanes are set to the deep low power consumption state. In contrast, in the memory system 3 of the second embodiment, an inactive lane that starts being used only when the link width is the maximum link width (in this example, x8) is set to a low power consumption state that has a small power reduction effect and a short exit latency (i.e., a shallow low power consumption state). In addition, in the memory system 3 of the second embodiment, an inactive lane that starts being used even when the link width is not maximum link width is set to a deep low power consumption state.

Specifically, when the required band 82 has decreased from the band corresponding to the link width x8 to the band corresponding to the link width x4 (i.e., when the required band 82 has become less than or equal to the third threshold value) at time t21, the memory system 3 of the second embodiment determines that the link width can be narrowed from x8 to x4 even in consideration of the projected future increase of the required band 82, since the exit latency is short. Accordingly, in the memory system 3 of the second embodiment, the link width is narrowed from x8 to x4.

In contrast, in the memory system of the comparative example, the link width is maintained at x8. In the memory system of the comparative example, a long exit latency is required to expand the link width from x4 to x8 again in response to the increase of the required band 82 after the link width is narrowed from x8 to x4 in response to the decrease of the required band 82. Thus, in the situation where the required band 82 repeatedly increases above and decreases below the third threshold value, the memory system of the comparative example, even when the required band 82 has decreased, may not be able to determine to narrow the link width from x8 to x4 in consideration of the relationship between the long exit latency and the projected future increase of the required band 82. For example, in the case the required band 82 having decreased, if a period until the projected future increase of the required band 82 (e.g., the period until the required band 82 is projected to exceed the third threshold value) is sufficiently long with respect to the exit latency, the memory system of the comparative example determines that the link width can be narrowed from x8 to x4. In contrast, when the period until the projected future increase of the required band 82 is equal to or shorter than the exit latency, the memory system of the comparative example determines that the link width cannot be narrowed from x8 to x4. At the time t21, although the required band 82 has decreased, the memory system of the comparative example determines that the link width cannot be narrowed from x8 to x4 and maintains the link width at x8, because the exit latency is long and it is therefore impossible to return without delay in response to the projected future increase of the required band 82.

Then, when the required band 82 has increased from the band corresponding to the link width x4 to the band corresponding to the link width x8 (i.e., when the required band 82 has exceeded the third threshold value) at time t22, the memory system 3 of the second embodiment expands the link width from x4 to x8 at time t23. In the memory system 3 of the second embodiment, the exit latency from when the expanding of the link width is required in response to the increase of the required band 82 until when the link width is expanded from x4 to x8 in response to the request is an exit latency tr, which is from the time t22 to the time t23. The exit latency tr corresponds to time for four lanes (e.g., the lanes 4 to 7) to return from a shallow low power consumption state (e.g., the first low power consumption state) to the normal operating state in the memory system 3 of the second embodiment. During the exit latency tr, the memory system 3 of the second embodiment can expand the link width from x4 to x8 without delay with respect to the increase of the required band 82. Thus, in the memory system 3 of the second embodiment, the link width can be changed to either x4 or x8 frequently in response to the increase and decrease of the required band 82 above and below the third threshold value.

In addition, during the period from the time t21 to the time t23, the power consumption 62 of the link 31 in the memory system 3 of the second embodiment, in which the link width is x4, is lower than the power consumption 72 of the link in the memory system of the comparative example, in which the link width is x8.

As described above, in the memory system of the comparative example, a long exit latency is required to expand the link width in response to the increase of the required band 82.

In contrast, in the memory system 3 of the second embodiment, when the link width is wide (e.g., x4), the link width can be expanded for a short exit latency. Thus, in the memory system 3, in the usage situation where the required band is high for a relatively long period, the link width can be changed frequently in response to the increase or decrease of the required band 82. Note that in the memory system 3 of the second embodiment, each of lanes (e.g., the lanes 1 to 3) which starts being used even when the link width is not the maximum link width is set to a deep low power consumption state (e.g., the third low power consumption state). Thus, when a narrow link width (e.g., x2) is expanded (e.g., expanded to x4), the following capability of the link width deteriorates. However, in the usage situation where the required band is high for a relatively long period, the possibility that it becomes necessary to narrow the link width is low in the first place. For example, the possibility that the lanes 1 to 3 are set to the third low power consumption state is low in the first place. Thus, the degradation of the performance of packet transfer is not considered a problem.

Accordingly, in the memory system 3, the operation of the lane circuits when the link width is narrowed can be optimized to achieve an exit latency and a power reduction effect that are suitable for the usage situation of the link 31 where the required band is high for a relatively long period.

### Third Embodiment

In the first embodiment, each lane of the link 31 is controlled in the usage situation of the link 31 where the required band is low for a relatively long period. In a third embodiment, each lane of the link 31 is controlled to further shorten the exit latency in the usage situation of the link 31 where the required band is low for a relatively long period.

The configuration of the memory system 3 according to the third embodiment is the same as that of the memory system 3 of the first embodiment. The third embodiment and the first embodiment are different in the control operation of lanes performed by the low-power controllers 42-0 to 42-7. In the following description, points different from those of the first embodiment will be mainly explained.

In the memory system 3 of the third embodiment, an example of the control of the lane circuits LC0 to LC7 performed in accordance with the variation of the link width when the link 31 is in the link power state L0p is the same as described above with reference to FIG. 4 to FIG. 7 in the first embodiment.

In the memory system 3 of the third embodiment, furthermore, the low power consumption state set for a lane which is to transition from inactive to active in response to the required band reaching a threshold value for determining whether to expand the link width, is changed in advance to a shallower low power consumption state. Specifically, for the required band, in addition to the threshold values for determining whether to change the link width, other threshold values (hereinafter, referred to as advance threshold values) for determining whether to change the details of the low power consumption state before changing the link width are provided.

For example, an advance threshold value (hereinafter, referred to as a first advance threshold value) for determining whether to change the details of the low power consumption state set for the lanes 2 and 3, which start being used in response to the expansion of the link width from x2 to x4, before changing the link width from x2 to x4 is provided. In this case, when the required band has exceeded the first advance threshold value, the low-power controllers 42-2 and 42-3 change the second low power consumption state that is set for the inactive lanes 2 and 3 to a shallower low power consumption state. Note that, for example, the NVMe controller 23 notifies the low-power controllers 42-2 and 42-3 via the link-width controller 41 that the required band has exceeded the first advance threshold value.

In addition, for example, an advance threshold value (hereinafter, referred to a second advance threshold value) for determining whether to change the details of the low power consumption state set for the lanes 4 to 7, which start being used in response to the expansion of the link width to x8, before changing the link width from x4 to x8 is provided. In this case, when the required band has exceeded the second advance threshold value, the low-power controllers 42-4 to 42-7 change the third low power consumption state that is set for the inactive lanes 4 to 7 to a shallower low power consumption state. Note that, for example, the NVMe controller 23 notifies the low-power controllers 42-4 to 42-7 via the link-width controller 41 that the required band has exceeded the second advance threshold value.

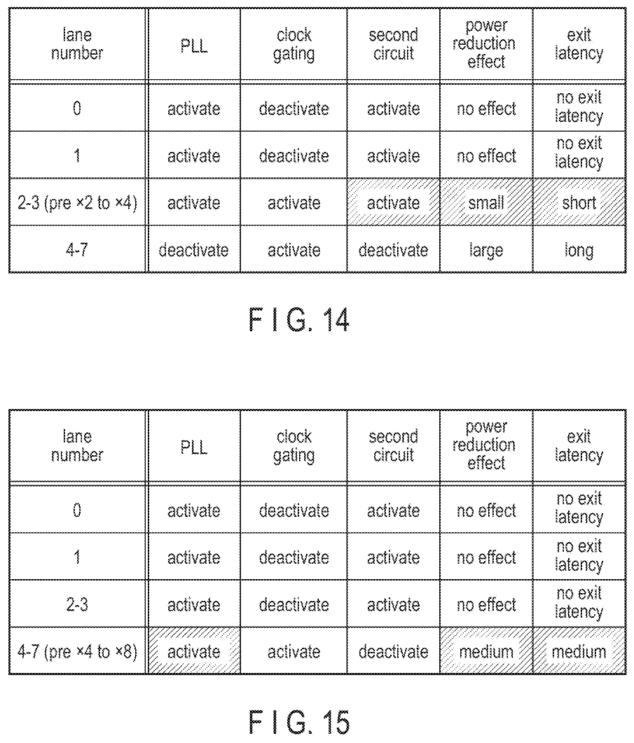

FIG. 14 illustrates a control example of the lane circuits LC0 to LC7 when the required band has exceeded the first advance threshold value while the link 31 is in the link power state L0p and the link width is x2. In this case, the lanes 0 and 1 (i.e., the lanes of the zeroth and first groups) are active lanes. The lanes 2 to 7 (i.e., the lanes of the second and third groups) are inactive lanes.

A control example of the lane circuits LC that respectively correspond to the lanes 0, 1, and 4 to 7 belonging to the zeroth, first, and third groups when the link width is x2 is the same as described above with reference to FIG. 5.

A control example of the lane circuits LC2 and LC3 that respectively correspond to the lanes 2 and 3 belonging to the second group will be explained.

As described above with reference to FIG. 5, when the link width is x2, the low-power controller 42-2 operates the lane circuit LC2 in the second low power consumption state. Specifically, the low-power controller 42-2 activates the PLL circuit 43-2. The low-power controller 42-2 activates the clock gating function of the clock gating circuit 44-2. That is, the supply of the clock CLK to the first circuit 45-2 is stopped. The low-power controller 42-2 deactivates the second circuit 46-2.

Then, when the required band has exceeded the first advance threshold value, the low-power controller 42-2 operates the lane circuit LC2 in a shallower low power consumption state as illustrated in FIG. 14. Specifically, the low-power controller 42-2 activates the second circuit 46-2.

In the same manner, when the link width is x2, the low-power controller 42-3 operates the lane circuit LC3 in the second low power consumption state. Then, when the required band has exceeded the first advance threshold value, the low-power controller 42-3 operates the lane circuit LC3 in the shallower low power consumption state.

With the above-described control, the power reduction effect in each of the lane circuits LC2 and LC3 becomes smaller, but the exit latency is shortened. In other words, the power consumption of the lane circuit LC in the shallower low power consumption state is greater than the power consumption of the lane circuit LC in the second low power consumption state. However, the duration for the lane circuit LC to transition from the shallower low power consumption state to the operating state is shorter than the duration for the lane circuit LC to transition from the second low power consumption state to the operating state.

In this manner, the low-power controllers 42-2 and 42-3 change the states of the lanes 2 and 3 (more specifically, the lane circuits LC2 and LC3) to the low power consumption state shallower than the second low power consumption state, when the link width is projected to be expanded from x2 to x4. This can shorten the exit latency when the link width is expanded from x2 to x4.

FIG. 15 illustrates a control example of the lane circuits LC0 to LC7 when the required band has exceeded the second advance threshold value while the link 31 is in the link power state L0p and the link width is x4. In this case, the lanes 0 to 3 (i.e., the lanes of the zeroth, first, and second groups) are active lanes. The lanes 4 to 7 (i.e., the lanes of the third group) are inactive lanes.

A control example of the lane circuits LC that respectively correspond to the lanes 0 to 3 belonging to the zeroth, first, and second groups when the link width is x4 is the same as described above with reference to FIG. 6.

A control example of the lane circuits LC4 to LC7 that respectively correspond to the lanes 4 to 7 belonging to the third group will be explained.

As described above with reference to FIG. 6, when the link width is x4, the low-power controller 42-4 operates the lane circuit LC4 in the third low power consumption state. Specifically, the low-power controller 42-4 deactivates the PLL circuit 43-4. The low-power controller 42-4 activates the clock gating function of the clock gating circuit 44-4. That is, the supply of the clock CLK to the first circuit 45-4 is stopped. The low-power controller 42-4 deactivates the second circuit 46-4.

Then, when the required band has exceeded the second advance threshold value, the low-power controller 42-4 operates the lane circuit LC4 in a shallower low power consumption state as illustrated in FIG. 15. Specifically, the low-power controller 42-4, for example, activates the PLL circuit 43-4.

The low-power controllers 42-5 to 42-7 also control the lane circuits LC5 to LC7, respectively, in the same manner as the low-power controller 42-4.

With the above-described control, the power reduction effect in each of the lane circuits LC4 to LC7 becomes smaller, but the exit latency is shortened. In other words, the power consumption of the lane circuit LC in the shallower low power consumption state is greater than the power consumption of the lane circuit LC in the third low power consumption state. However, the duration for the lane circuit LC to transition from the shallower low power consumption state to the operating state is shorter than the duration for the lane circuit LC to transition from the third low power consumption state to the operating state.

In this manner, the low-power controllers 42-4 to 42-7 change the states of the lanes 4 to 7 (more specifically, the lane circuits LC4 to LC7) to the low power consumption state shallower than the third low power consumption state, when the link width is projected to be expanded from x4 to x8. This can shorten the exit latency when the link width is expanded from x4 to x8.

Note that each of the low-power controllers 42-0 to 42-7 stores, for example, a table that indicates the contents of the control of the corresponding lane circuit LC, among the contents of the control of the lane circuits LC0 to LC7 that are performed in accordance with the link width in the link power state L0p and the required band as illustrated in FIG. 4 to FIG. 7, FIG. 14, and FIG. 15. Each of the low-power controllers 42-0 to 42-7 uses the table to control at least part of the corresponding lane circuit LC in accordance with the link width notified by the link-width controller 41. In addition, each of the low-power controllers 42-2 and 42-3 uses the table to control at least part of the corresponding lane circuit LC2 or LC3 in response to being notified by the link-width controller 41 that the required band has exceeded the first advance threshold value. Each of the low-power controllers 42-4 to 42-7 uses the table to control at least part of the corresponding one of the lane circuits LC4 to LC7 in response to being notified by the link-width controller 41 that the required band has exceeded the second advance threshold value.

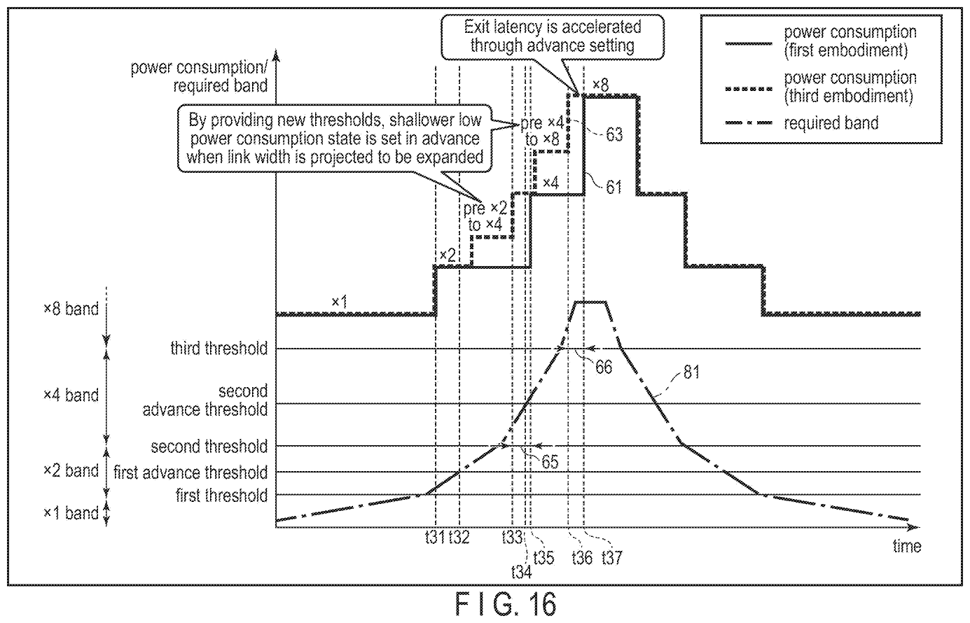

FIG. 16 is a graph indicating: an example of the power consumption of the link 31 in the memory system 3 of the first embodiment; and an example of the power consumption of the link 31 in the memory system 3 of the third embodiment, when the link width is controlled in accordance with the required band in the usage situation where the required band is low for a relatively long period. The horizontal axis represents time. The vertical axis represents the power consumption and the required band. It is assumed that with the passage of time, the required band 81 gradually increases from the band corresponding to the link width x1 to the band corresponding to the link width x8 and then gradually decreases to the band corresponding to the link width x1 again. The required band 81 represents the usage situation where the required band is low for a relatively long period.

The power consumption 61 of the link 31 in the memory system 3 of the first embodiment and the power consumption 63 of the link 31 in the memory system 3 of the third embodiment increase because of the expansion of the link width in response to the increase of the required band 81. In addition, the power consumption 61 and the power consumption 63 decrease because of the narrowing of the link width in response to the decrease of the required band 81.

Moreover, in response to the required band 81 having exceeded the first advance threshold value while the link width is x2, the lanes 2 and 3 of the second group are set to a shallower low power consumption state, and the power consumption 63 thereby increases. In response to the required band 81 having exceeded the second advance threshold value while the link width is x4, the lanes 4 to 7 of the third group are set to a shallower low power consumption state, and the power consumption 63 thereby increases.

Specifically, the time (i.e., return time) when the link width is expanded from x1 to x2 in response to the required band 81 having exceeded the first threshold value is time t31 in both the memory system 3 of the first embodiment and the memory system 3 of the third embodiment. The time t31 corresponds to the time when one lane (e.g., the lane 1) returns from a shallow low power consumption state (e.g., the first low power consumption state) to the normal operating state in each of the memory system 3 of the first embodiment and the memory system 3 of the third embodiment.

Then, in response to the required band 81 having exceeded the first advance threshold value at time t32, the memory system 3 of the third embodiment changes the lanes 2 and 3 of the second group to a shallower low power consumption state (“pre x2 to x4” in FIG. 16). Since the lanes 2 and 3 are changed to the shallower low power consumption state, the power consumption 63 of the link 31 in the memory system 3 of the third embodiment becomes higher than the power consumption 61 in the memory system 3 of the first embodiment.

The time when the link width is expanded from x2 to x4 in response to the required band 81 having exceeded the second threshold value is time t33 in the memory system 3 of the third embodiment and is time t35 in the memory system 3 of the first embodiment. The time t33 is earlier than the time t35 by a period 65. The time t33 corresponds to the time when two lanes (e.g., the lanes 2 and 3) return from the shallower low power consumption state to the normal operating state in the memory system 3 of the third embodiment. The time t35 corresponds to the time when two lanes (e.g., the lanes 2 and 3) return from a relatively deep low power consumption state (e.g., the second low power consumption state) to the normal operating state in the memory system 3 of the first embodiment. In the memory system 3 of the third embodiment, since the lanes 2 and 3 are set in advance to the shallower low power consumption state, the exit latency can be further shortened than in the memory system 3 of the first embodiment by the period 65.

In addition, in response to the required band 81 having exceeded the second advance threshold value at time t34 between the time t33 and the time t35, the memory system 3 of the third embodiment changes the lanes 4 to 7 of the third group to a shallower low power consumption state (“pre x4 to x8” in FIG. 16). Since the lanes 4 to 7 are changed to the shallower low power consumption state, the power consumption 63 of the memory system 3 of the third embodiment becomes greater than the power consumption 61 of the memory system 3 of the first embodiment.

The time when the link width is expanded from x4 to x8 in response to the required band 81 having exceeded the third threshold value is time t36 in the memory system 3 of the third embodiment and is time t37 in the memory system 3 of the first embodiment. The time t36 is earlier than the time t37 by a period 66. The time t36 corresponds to the time when four lanes (e.g., the lanes 4 to 7) return from the shallower low power consumption state to the normal operating state in the memory system 3 of the third embodiment. The time t37 corresponds to the time when four lanes (e.g., the lanes 4 to 7) return from a deep low power consumption state (e.g., the third low power consumption state) to the normal operating state in the memory system 3 of the first embodiment. In the memory system 3 of the third embodiment, since the lanes 4 to 7 are set in advance to the shallower low power consumption state, the exit latency can be further shortened than in the memory system 3 of the first embodiment by the period 66.

In this manner, in the memory system 3 of the third embodiment, in response to the required band 81 having exceeded the first advance threshold value, the lanes 2 and 3 of the second group are changed to the shallower low power consumption state. In addition, in the memory system 3 of the third embodiment, in response to the required band 81 having exceeded the second advance threshold value, the lanes 4 to 7 of the third group are changed to the shallower low power consumption state. While the lanes 2 and 3 of the second group are in the shallower low power consumption state and the period for which the lanes 4 to 7 of the third group are in the shallower low power consumption state, the power reduction effect of the memory system 3 of the third embodiment is smaller than that of the memory system 3 of the first embodiment. However, in the memory system 3 of the third embodiment, the exit latency when the link width is expanded from x2 to x4 and the exit latency when the link width is expanded from x4 to x8 can be shortened more than in the memory system 3 of the first embodiment. Accordingly, in the memory system 3 of the third embodiment, the following capability of the link width when the link width is expanded from x2 to x4 and when the link width is expanded from x4 to x8 can be improved more than in the memory system 3 of the first embodiment.

Accordingly, in the memory system 3 of the third embodiment, the operation of the lane circuit LC when the link width is narrowed can be optimized to achieve an exit latency and a power reduction effect which are suitable for the usage situation of the link 31 where the required band is low is for a relatively long period, and the exit latency can be shortened.

As described above, according to the embodiments, the operations in a case where the link width is narrowed can be improved. The link 31 includes a plurality of lanes. For example, the plurality of lanes in the link 31 includes at least one zeroth lane, a first lane, and a second lane. The controller 6 (more specifically, the link-width controller 41 and the low-power controllers 42-0 to 42-7) sets the at least one zeroth lane to the operating state, sets the first lane to the first low power consumption state, and sets the second lane to the second low power consumption state, on the basis of the band required for data transfer between the host 2 and the memory system 3 via the link 31. The power consumption in each of the first low power consumption state and the second low power consumption state is lower than the power consumption in the operating state. The duration of transition from the first low power consumption state to the operating state is different from the duration of transition from the second low power consumption state to the operating state.

Accordingly, when the link 31 is in the link power state L0p, the controller 6 can, for example, set inactive lanes to different low power consumption states per lane or per unit of lanes whose states transition simultaneously. Thus, in the memory system 3, for example, the operation of the lane circuits when the link width is narrowed can be improved to achieve an exit latency and a power reduction effect that are suitable for the usage situation of the link 31.

Each of various functions described in the first to third embodiments may be realized by a circuit (e.g., processing circuit). An exemplary processing circuit may be a programmed processor such as a central processing unit (CPU). The processor executes computer programs (instructions) stored in a memory thereby performs the described functions. The processor may be a microprocessor including an electric circuit. An exemplary processing circuit may be a digital signal processor (DSP), an application specific integrated circuit (ASIC), a microcontroller, a controller, or other electric circuit components. The components other than the CPU described according to the embodiments may be realized in a processing circuit.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A memory system connectable to a host, comprising:
a nonvolatile memory; and
a controller configured to:
control the nonvolatile memory; and
in accordance with a band required for data transfer via a link between the host and the memory system, the link including a plurality of lanes, the plurality of lanes including at least one zeroth lane, a first lane, and a second lane,
set the at least one zeroth lane to an operating state,
set the first lane to a first low power consumption state, and
set the second lane to a second low power consumption state,
wherein
power consumption in each of the first low power consumption state and the second low power consumption state is lower than power consumption in the operating state, and
a duration of transition from the first low power consumption state to the operating state is different from a duration of transition from the second low power consumption state to the operating state.

2. The memory system according to claim 1, wherein
the duration of transition from the second low power consumption state to the operating state is longer than the duration of transition from the first low power consumption state to the operating state.

3. The memory system according to claim 2, wherein
the power consumption in the second low power consumption state is smaller than the power consumption in the first low power consumption state.

4. The memory system according to claim 3, wherein
the controller includes a plurality of phase-locked loop circuits that correspond to the plurality of lanes, respectively, and
the controller is further configured to:
activate the phase-locked loop circuit that corresponds to the zeroth lane in the operating state;
activate the phase-locked loop circuit that corresponds to the first lane in the first low power consumption state; and
deactivate the phase-locked loop circuit that corresponds to the second lane in the second low power consumption state.

5. The memory system according to claim 3, wherein
the controller includes a plurality of clock gating circuits that correspond to the plurality of lanes, respectively, each of the plurality of clock gating circuits having a clock gating function, and
the controller is further configured to:
deactivate the clock gating function of the clock gating circuit that corresponds to the zeroth lane in the operating state;
activate the clock gating function of the clock gating circuit that corresponds to the first lane in the first low power consumption state; and
activate the clock gating function of the clock gating circuit that corresponds to the second lane in the second low power consumption state.

6. The memory system according to claim 3, wherein
the controller includes a plurality of specific circuits that correspond to the plurality of lanes, respectively, and
the controller is further configured to:
activate the specific circuit that corresponds to the zeroth lane in the operating state;
activate the specific circuit that corresponds to the first lane in the first low power consumption state; and
deactivate the specific circuit that corresponds to the second lane in the second low power consumption state.

7. The memory system according to claim 1, wherein
the duration of transition from the second low power consumption state to the operating state is shorter than the duration of transition from the first low power consumption state to the operating state.

8. The memory system according to claim 7, wherein
the power consumption in the second low power consumption state is larger than the power consumption in the first low power consumption state.

9. The memory system according to claim 1, wherein
the controller is further configured to, in response to the band having exceeded a first advance threshold value, transition the first lane from the first low power consumption state to a third low power consumption state, and
a duration of transition from the third low power consumption state to the operating state is shorter than the duration of transition from the first low power consumption state to the operating state.

10. The memory system according to claim 9, wherein
power consumption in the third low power consumption state is larger than the power consumption in the first low power consumption state.

11. The memory system according to claim 10, wherein
the controller includes:
a plurality of phase-locked loop circuits that correspond to the plurality of lanes, respectively;
a plurality of clock gating circuits that correspond to the plurality of lanes, respectively, each of the plurality of clock gating circuits having a clock gating function; and
a plurality of specific circuits that correspond to the plurality of lanes, respectively, and
the controller is further configured to:
activate the phase-locked loop circuit that corresponds to the first lane in the third low power consumption state;
activate the clock gating function of the clock gating circuit that corresponds to the first lane in the third low power consumption state; and
activate the specific circuit that corresponds to the first lane in the third low power consumption state.

12. The memory system of according to claim 1, wherein
the controller is further configured to:
in response to the band having exceeded a first threshold value, transition the first lane from the first low power consumption state to the operating state; and
in response to the band having exceeded a second threshold value, transition the second lane from the second low power consumption state to the operating state, the second threshold value being larger than the first threshold value.

13. The memory system of according to claim 1, wherein
the controller is further configured to:
project the band required for data transfer via the link, on the basis of the number of commands that have not been accepted yet by the memory system after being issued by the host.

14. The memory system of according to claim 1, wherein
the duration of transition from the first low power consumption state to the operating state is, a duration from time when a width of the link is required to be expanded in response to an increase of the band required for data transfer via the link to time when the first lane transitions from the first low power consumption state to the operating state.

15. The memory system of according to claim 14, wherein
the width of the link is represented by the number of active lanes in the link, each of the active lanes being a lane in the operating state.

16. The memory system according to claim 1, wherein
the controller includes a table configured to store setting for each of the plurality of lanes, the setting being determined based on a width of the link.

17. The memory system according to claim 1, wherein
each of the plurality of lanes includes a signal line for a signal transferred from the host to the memory system, and a signal line for a signal transferred from the memory system to the host.

18. The memory system of according to claim 1, wherein
the link which includes the at least one zeroth lane in the operating state, the first lane in the first low power consumption state, and the second lane in the second low power consumption state, is in an L0p state defined in a PCIe standard.

19. A memory system connectable to a host via a link including a plurality of lanes, comprising:
a nonvolatile memory; and
a controller configured to:
in a case where a band required for data transfer between the host and the memory system via the link is projected to be lower than a threshold for a period longer than a threshold period,
control power consumption states of the plurality of lanes in such a way that:
the wider a width of the link at time when a first lane of the plurality of lanes starts being used is, the deeper a low power consumption state of the first lane is; and
the narrower the width of the link at time when a second lane of the plurality of lanes starts being used is, the shallower the low power consumption state of the second lane is.

20. A memory system connectable to a host via a link including a plurality of lanes, comprising:
a nonvolatile memory; and
a controller configured to:
in a case where a band required for data transfer between the host and the memory system via the link is projected to be higher than a threshold for a period longer than a threshold period,
transition a first lane of the plurality of lanes that starts being used only when a width of the link is its maximum width to a shallower low power consumption state than a second lane of the plurality of lanes that starts being used even when the width of the link is not its maximum width.
